(19) United States
(12) Patent Application Publication
(10) Pub. No.: US 2024/0155606 A1
(43) Pub. Date: May 9, 2024

(54) ENHANCED MULTI-LAYER UPLINK TRANSMISSION

(71) Applicant: Intel Corporation, Santa Clara, CA (US)

(72) Inventors: Guotong Wang, Beijing (CN); Alexei Davydov, Nizhny Novgorod (RU)

(21) Appl. No.: 18/550,570

(22) PCT Filed: Jul. 21, 2022
(86) PCT No.: PCT/US2022/037907

§ 371 Date: Sep. 14, 2023

(30) Foreign Application Priority Data
Jul. 23, 2021 (WO) PCT/CN2021/108106
Sep. 10, 2021 (WO) PCT/CN2021/117705
Dec. 9, 2021 (WO) PCT/CN2021/136664

(51) Int. Cl. H04W 72/1268; H04L 1/00; H04L 5/00; H04W 72/232

(52) U.S. Cl. CPC H04W 72/1268; H04L 1/0003; H04L 5/0051; H04W 72/232

(57) ABSTRACT

Systems, apparatuses, methods, and computer-readable media are provided to support multiple codewords and/or transmission of uplink transmissions (e.g., PUSCH) with more than 4 layers. Additionally, embodiments provide techniques for frequency selective precoding for uplink transmission. Other embodiments may be described and claimed.

### CROSS REFERENCE TO RELATED APPLICATION

The present application claims priority to International Patent Application No. PCT/CN2021/108106, which was filed Jul. 23, 2021; international Patent Application No. PCT/CN2021/117705, which was filed Sep. 10, 2021, and to International Patent Application No. PCT/CN2021/136664, which was filed Dec. 9, 2021.

### FIELD

Various embodiments generally may relate to the field of wireless communications.

### BACKGROUND

In 3GPP New Radio (NR) Rel-15/Rel-16 specification, for uplink transmission, up to 4 layers can be supported for physical uplink shared channel (PUSCH). Additionally, only one codeword is configured for PUSCH.

### BRIEF DESCRIPTION OF THE FIGURES

FIG. 1 illustrates a codeword to layer mapping for PUSCH in New Radio (NR) Release 15/16.

FIG. 2 illustrates precoding matrixes for single-layer transmission using two antenna ports.

FIG. 3 illustrates precoding matrixes for two-layer transmission using two antenna ports with transform precoding disabled.

FIG. 4 illustrates precoding matrixes for single-layer transmission using four antenna ports with transform precoding enabled.

FIG. 5 illustrates precoding matrixes for single-layer transmission using four antenna ports with transform precoding disabled.

FIG. 6 illustrates precoding matrixes for two-layer transmission using four antenna ports with transform precoding disabled.

FIG. 7 illustrates precoding matrixes for three-layer transmission using four antenna ports with transform precoding disabled.

FIG. 8 illustrates precoding matrixes for four-layer transmission using four antenna ports with transform precoding disabled.

FIG. 9 illustrates mapping between codeword and layers in accordance with various embodiments.

FIG. 10 illustrates an example of multiple codewords uplink in multi-TRP, in accordance with various embodiments.

FIGS. 11A-11C illustrate an example of an 8-layer precoder for 8 antenna ports, in accordance with various embodiments.

FIGS. 12A-12C illustrate an example of a 7-layer precoder for 8 antenna ports, in accordance with various embodiments.

FIG. 13 illustrates an example of a Rank-1 partial coherent TPMI codebook for an 8-Tx UE with four oscillators, in accordance with various embodiments.

FIGS. 14A-14B illustrate an example of a Rank-1 partial coherent TPMI codebook for an 8-Tx UE with two oscillators, in accordance with various embodiments.

FIGS. 15A and 15B illustrate operation of codebook-based and non-codebook-based physical uplink shared channel (PUSCH) transmission, respectively.

FIG. 16 illustrates an example of PUSCH bandwidth partition with PRGs for frequency selective precoding, in accordance with various embodiments.

FIG. 17 illustrates a transmission precoding matrix index (TPMI) indication for frequency selective precoding with codebook-based uplink transmission, in accordance with various embodiments.

FIG. 18 illustrates an example of sounding reference signal (SRS) resource indicator (SRI) indication for frequency selective precoding with non-codebook-based uplink transmission, in accordance with various embodiments.

FIG. 19 illustrates a network in accordance with various embodiments.

FIG. 20 schematically illustrates a wireless network in accordance with various embodiments.

FIG. 21 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 22, 23, and 24 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Various embodiments herein provide techniques to support multiple codewords and/or transmission of uplink transmissions (e.g., PUSCH) with more than 4 layers. Additionally, embodiments provide techniques for frequency selective precoding for uplink transmission.

Enhanced Multi-Laver Uplink Transmission

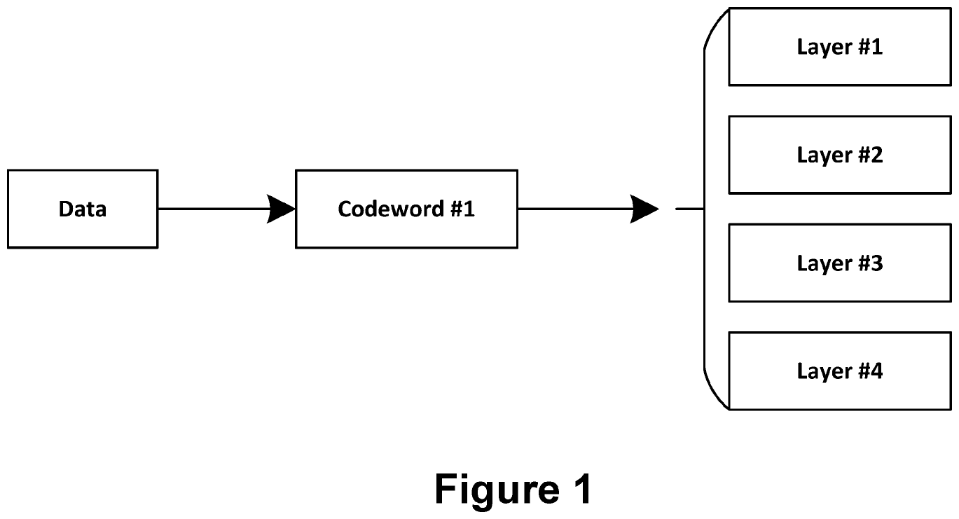

As discussed above, in NR Rel-15/Rel-16 spec, for uplink transmission, up to 4 layers can be supported for PUSCH. Additionally, only one codeword is configured for PUSCH. FIG. 1 shows the mapping between codeword and layers for PUSCH in Rel-15/Rel-16.

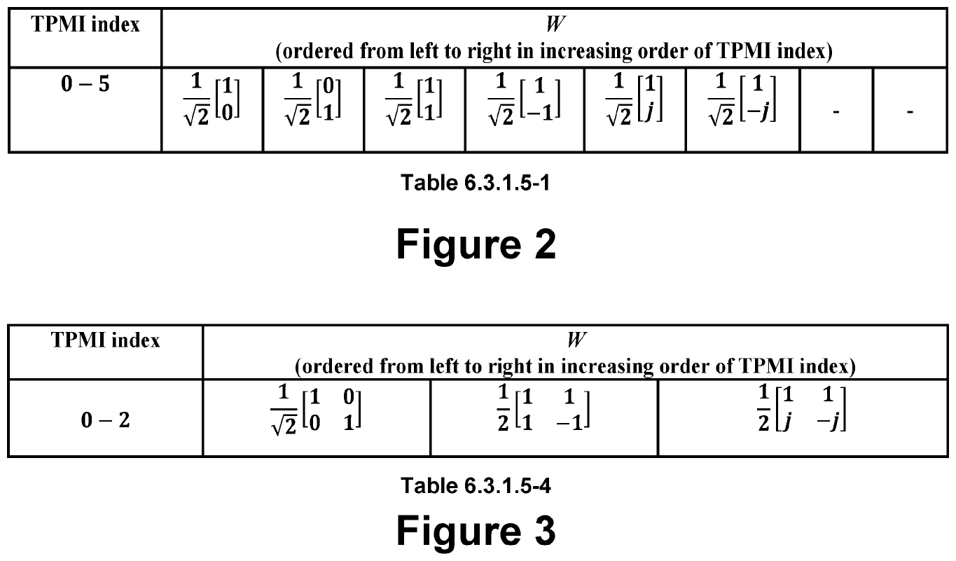

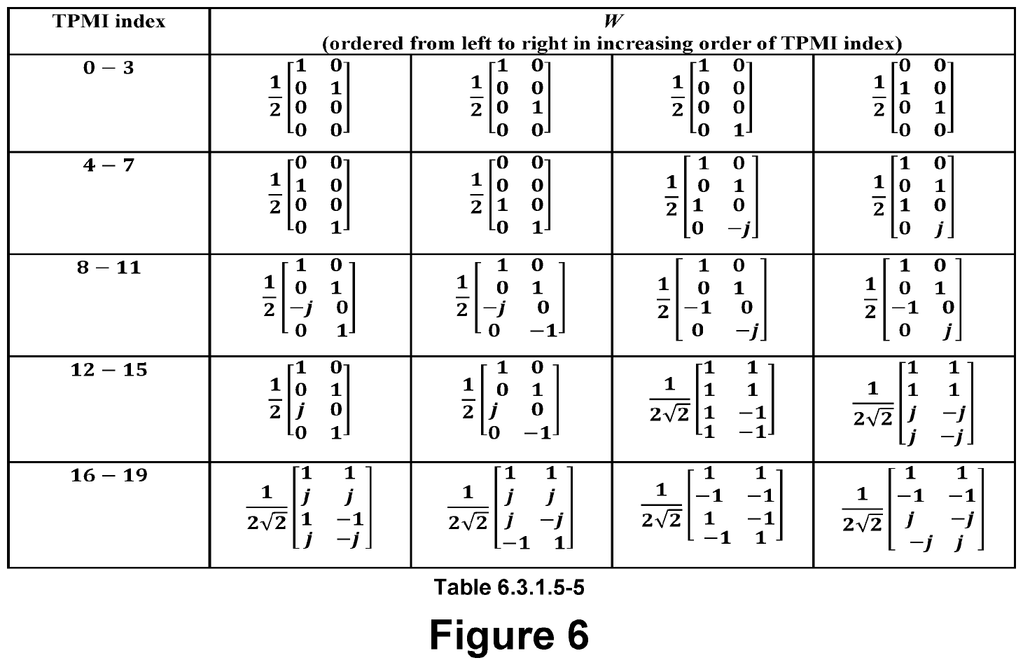

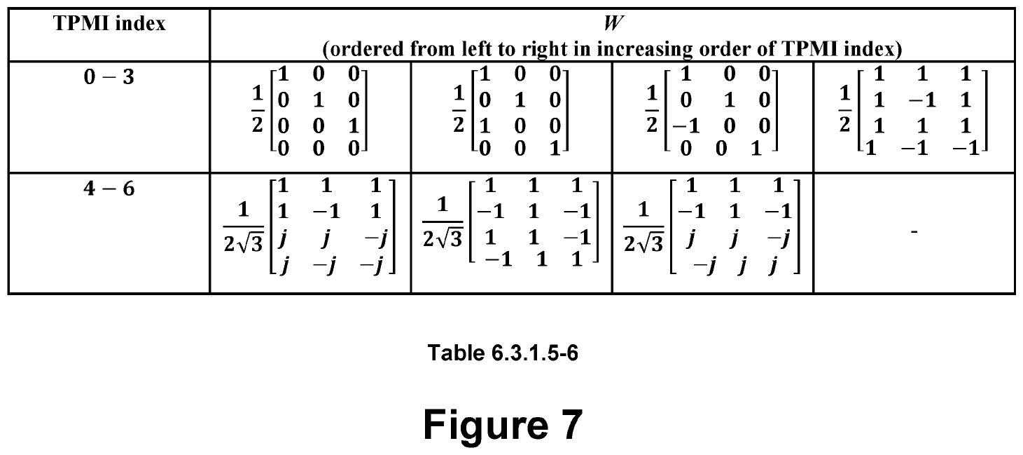

In NR Rel-15/Rel-16, the precoders (TPMIs) for uplink PUSCH transmission are defined in 3GPP Technical Specification (TS) 38.211, depending on the rank value (e.g., number of layers), number of antenna ports and waveform (e.g., CP-OFDM or DFT-s-OFDM), as shown from FIG. 2 to FIG. 8.

In order to improve uplink spectral efficiency, more than 4 layers uplink transmission may be supported in future NR releases, e.g., NR Rel-18. Various embodiments herein provide techniques to support multiple codewords and/or transmission of PUSCH with more than 4 layers. For example, new precoders (e.g., TPMIs) may be defined for more than 4 layers uplink transmission. Additionally, or alternatively, the uplink DCI format may be enhanced to support multiple codewords operation.

Multiple Codewords for Uplink Transmission

In an embodiment, multiple codewords (e.g., two or more codewords) may be introduced for PUSCH. The multiple codewords may enable more than four layers (e.g. 8 layers) uplink transmission.

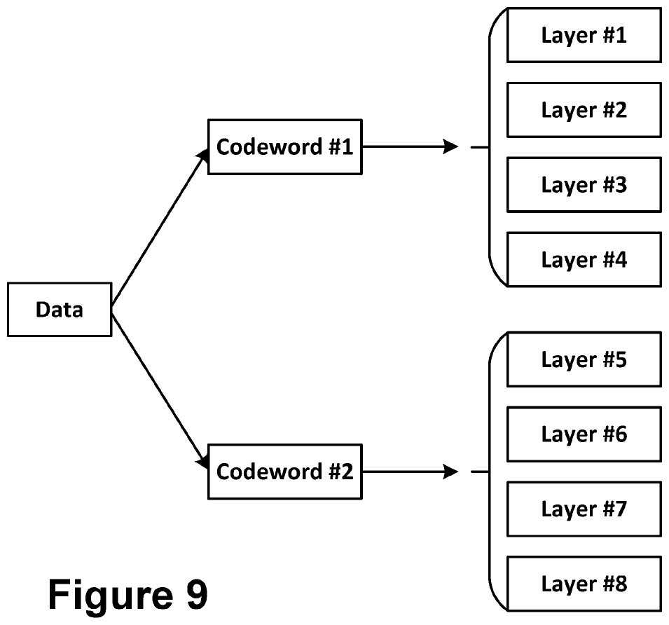

In one example, a first codeword may be mapped to layer 1 to layer 4, and a second codeword may be mapped to layer 5 to layer 8. FIG. 9 shows an example of the operation.

In an embodiment, in the uplink DCI format 0_1/0_2 or any other DCI format which can schedules PUSCH transmission, the DCI format could include multiple of following fields (e.g., one field for each of the multiple codewords). In some embodiments, the presence of the field for the second codeword could be configurable.
Multiple Modulation and Coding Scheme (MCS) fields, for example, two MCS fields. The first MCS field is applied to the first codeword, the second MCS field is applied to the second codeword.
Multiple New Data Indicator (NDI) fields, for example, two NDI fields. The first NDI field is applied to the first codeword, the second NDI field is applied to the second codeword.
Multiple Redundancy Version (RV) fields, for example, two RV fields. The first RV field is applied to the first codeword, the second RV field is applied to the second codeword.

In an embodiment, for codebook based uplink transmission with multiple codewords, in the uplink DCI format 0_1/0_2 or any other DCI format which can schedules PUSCH transmission, the DCI format could include multiple Precoding Information and Number of Layers fields, e.g. two fields, to indicate the TPMI used for uplink transmission. The first Precoding Information and Number of Layers field is applied to the first codeword, the second Precoding Information and Number of Layers field is applied to the second codeword, e.g. the TPMIs are generated per codeword. The TPMIs could be extended to more than four layers (e.g. 8-port precoder) or kept as four layers (e.g. 4-port precoder).

In one example, different MCS/rank and TPMIs could be applied for different codeword. In another example, the same MCS/rank and TPMIs could be applied for all the codewords.

In another embodiment, the uplink transmission with multiple codewords could be applied for multi-TRP enhanced mobile broadband (eMBB) operation. For example, the first codeword is applied to the transmission toward the first TRP, and the second codeword is applied to the transmission toward the second TRP. Correspondingly, the multiple MCS/NDI/RV/TPMIs fields in the DCI may be applied for transmission toward different TRPs. The TPMIs could be extended to more than four layers or kept as four layers.

In one example, different MCS/rank and TPMIs could be applied for different codeword/different TRP. In another example, the same MCS/rank and TPMIs could be applied for all the codewords/all the TRPs.

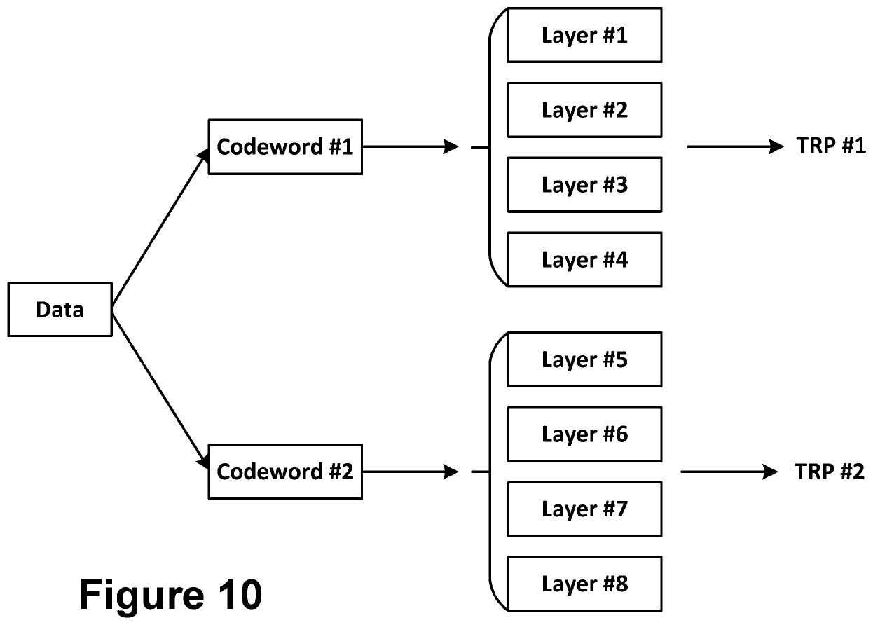

FIG. 10 shows an example of the operation.

In another embodiment, for uplink transmission with multiple codewords, multiple sounding reference signal (SRS) resource indicators (SRIs) may be included in the DCI. For example, if N codewords are configured to the UE, then N SRI field may be included in the DCI (one SRI field for each codeword). Correspondingly, multiple SRS resource sets may be configured to the UE, and each SRS resource set may correspond to one codeword. For the multiple SRS resource sets, the number of SRS resources within each SRS resource set may be the same or different, and the number of ports for SRS resource may be the same or different.

The number of SRS ports of the SRS resource indicated by different SRI fields could be the same or different for different codewords. For example, both SRIs may indicate 4-port SRS. In another example, the 1^{st} SRI indicates 4-port SRS for the 1^{st} codeword, and the 2^{nd} SRI indicates 2-port SRS for the 2^{nd} codeword.

The spatial relation of the SRS resource indicated by different SRI field could be the same or different for different codeword. For example, if the UE does not support simultaneous transmission from multiple panels, then the spatial relation of the indicated SRS resources by different SRI fields may be the same, or the same spatial relation/TCI state may be configured for the SRS resources in different SRS resource sets. In another example, if the UE supports simultaneous transmission from multiple panels, then different spatial relation could be indicated by different SRI fields.

In another example, for uplink transmission with multiple codewords, multiple SRIs may be included in the DCI and only one SRS resource set is configured for the UE, different SRI field is applied for different codeword. Alternatively, only one SRS resource set is configured for the UE, and only one SRI field is included in the DCI, the indicated SRI is applied for all the codewords. In another option, only one SRI field is included in the DCI, and the SRI could indicate multiple SRS resources.

The mapping between SRI field in DCI and the codeword could be implicit or explicit. With implicit mapping, the order of the SRI field may indicate which codeword it is applied to. For example, the 1^{st} SRI field is applied to the 1^{st} codeword and the 2^{nd} SRI field is applied to the 2^{nd} codeword. With explicit mapping, the mapping between SRI field and codeword could be indicated by DCI or configured by RRC. For example, a new field could be added to DCI or the existing field could be reused/repurposed.

Whether one codeword is used for transmission could implicitly indicated, for example, by the SRI or TPMI field. If one codeword is not used for transmission, in the corresponding SRI field, one specific value (for example, one reserved value) of the SRI field could be used to indicate that the corresponding codeword is not used for transmission.

In another example, whether the codeword is used for transmission or not could be explicitly indicated by DCI. For example, a new field could be added to DCI or the existing field could be reused/repurpose. In one example, the new field could be a bitmap of two bits.

In another embodiment, the transmission of the multiple codewords could be time-division multiplexed (TDMed), frequency-division multiplexed (FDMed), and/or spatial-division multiplexed (SDMed).

In the DCI scheduling PUSCH transmission, one or multiple FDRA (Frequency Domain Resource Assignment) fields may be included. Additionally, or alternatively, one or multiple TDRA (Time Domain Resource Assignment) fields may be included in the DCI.

When multiple FDRA/TDRA fields are included in the DCI, each FDRA/TDRA may be for one codeword. When only one FDRA/TDRA field is included in the DCI, the same FDRA/TDRA may be applied for all the codewords. In some embodiments, one FDRA/TDRA field may indicate multiple frequency/time resource allocations.

For example, for FDMed multiple codeword transmission, multiple FDRA fields are included and each FDRA is for one codeword. Additionally, one TDRA could be included in the DCI, which is applied to all the codewords.

In another example, for FDMed multiple codeword transmission, one FDRA field is included in the DCI. The frequency resource division among different codeword could be configured or predefined. For example, if the FDRA field indicate the resource allocation of N PRBs, then a subset of the N PRBs could be applied for each codeword.

In another embodiment, for the transmission of multiple codewords, the same HARQ process should be applied for all the codewords. In another example, different HARQ process could be applied for different codeword.

In another embodiment, for the transmission of multiple codewords, multiple Antenna Ports field could be included in the scheduling DCI indicating the DMRS configuration for different codeword, e.g, one Antenna Ports field is for one codeword. In another example, only one Antenna Ports field is included in the scheduling DCI, which is applied for all the codewords.

Single Codeword for Uplink Transmission

In an embodiment, only one codeword is used for PUSCH to support more than four layers (e.g. 8 layers) uplink transmission. In this case, in the uplink DCI format 0_1/0_2 or any other DCI format which can schedules PUSCH transmission, the DCI format includes only one MCS/RV/NDI field and only one Precoding Information and Number of Layers field. Correspondingly, the TPMIs should be extended to more than four layers (e.g. 8-port precoder).

In an embodiment, for rank-x (x is integer and 1≤x≤4) with 8 antenna ports, the precoders could be generated by the Kronecker product of rank-1 precoder with 2 ports and rank-x precoder with 4 ports.

For example, the rank-1 precoder W for 8 ports can be generated by the following equation:

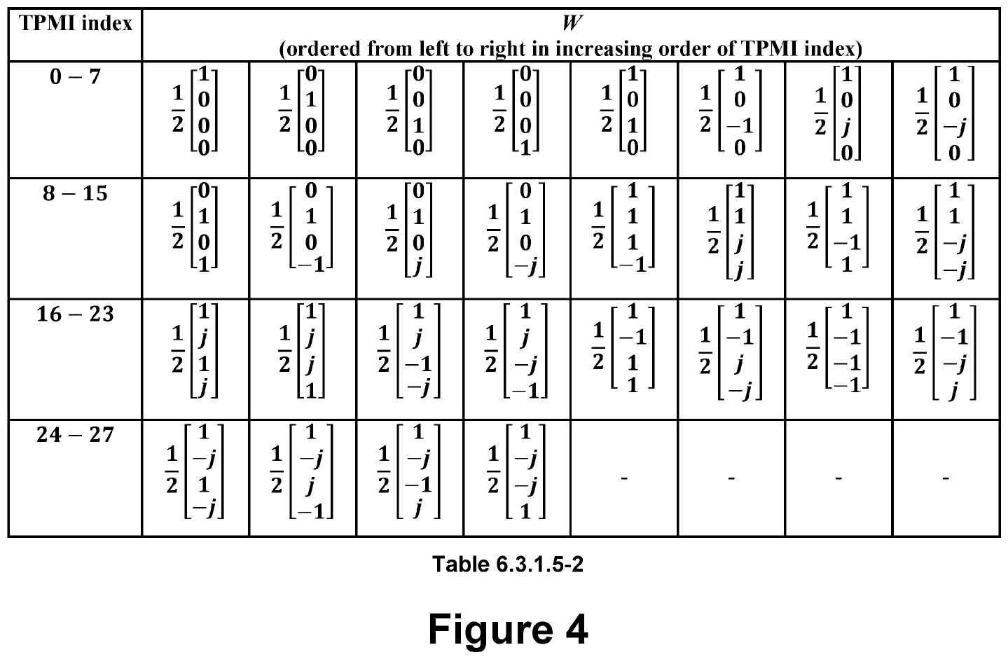

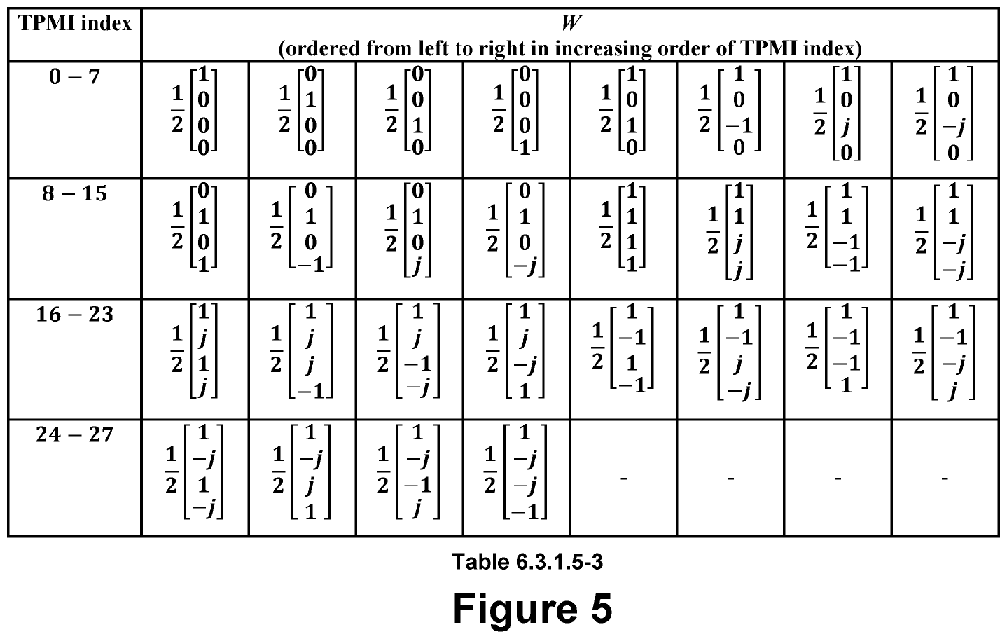

W=W₁⊗W₂

where W₁ is one rank-1 precoder with 2-port selected from FIG. 2, W₂ is one rank-1 precoder with 4-port selected from FIG. 5 or FIG. 4 (depending on the waveform), ⊗ means Kronecker product operation.

In an embodiment, for rank-x (x=6, 8) with 8 antenna ports, the precoders could be generated by the Kronecker product of rank-2 precoder with 2 ports and rank-(x/2) precoder with 4 ports.

For example, the rank-8 precoder W for 8 ports can be generated by the following equation:

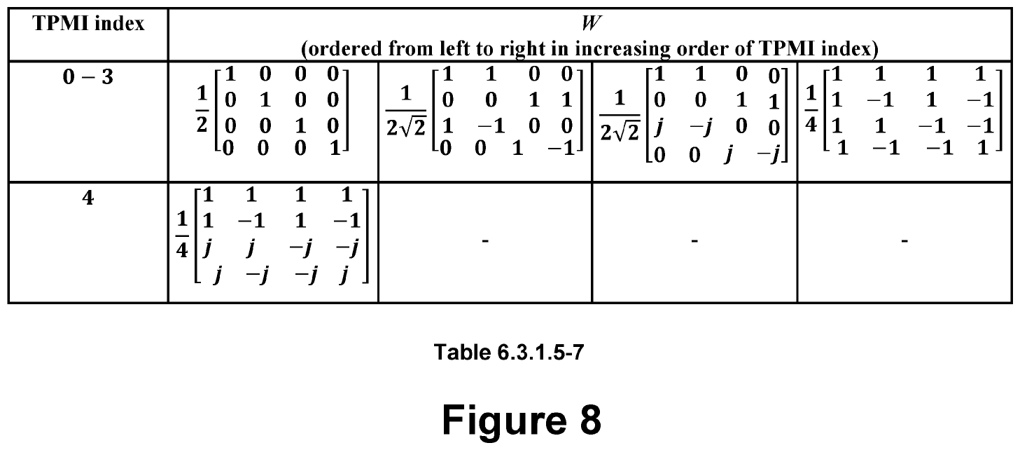

W=W₁⊗W₂

where W₁ is one rank-2 precoder with 2-port selected from FIG. 3, W₂ is one rank-4 precoder with 4-port selected from FIG. 8, ⊗ means Kronecker product operation.

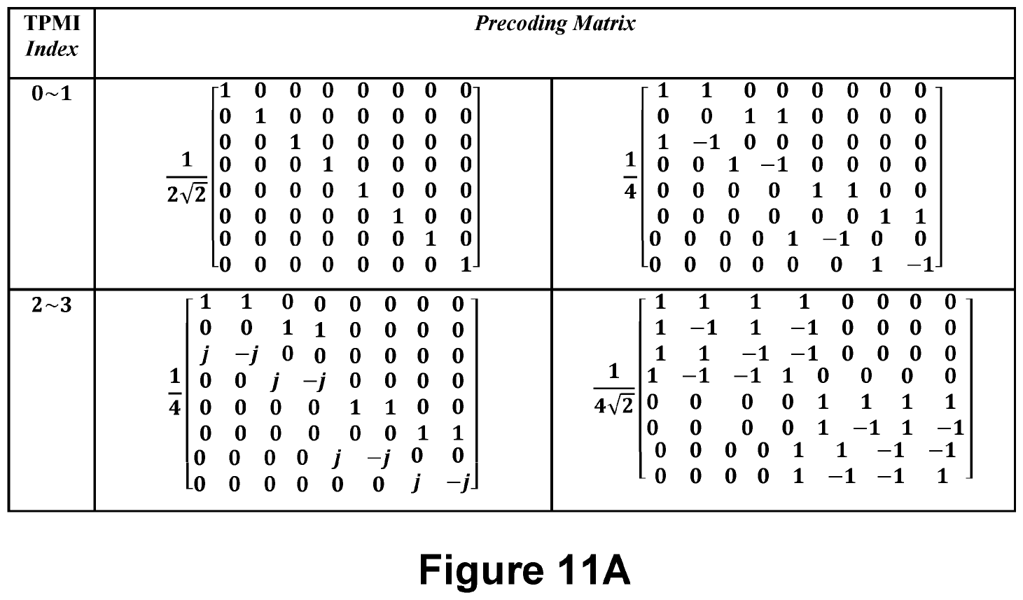

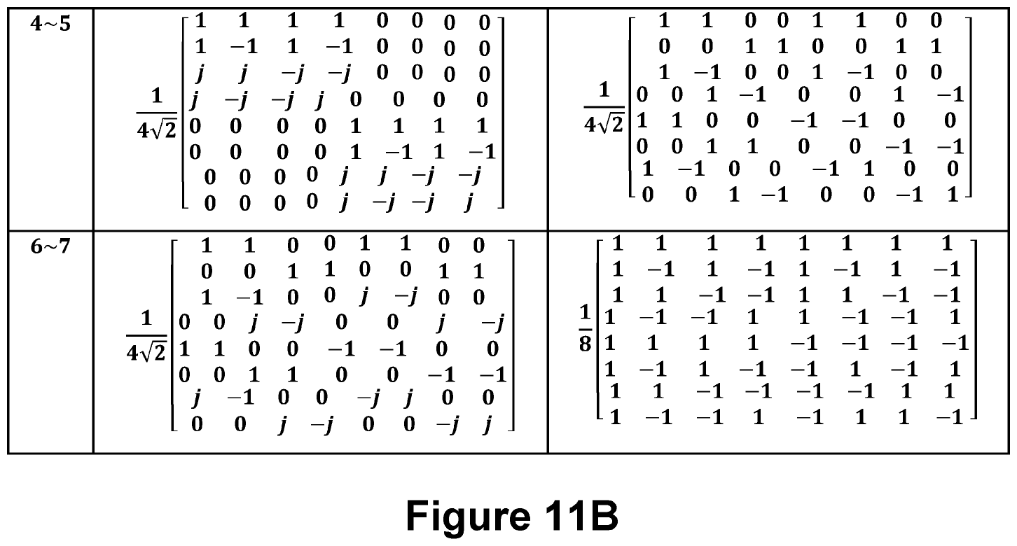

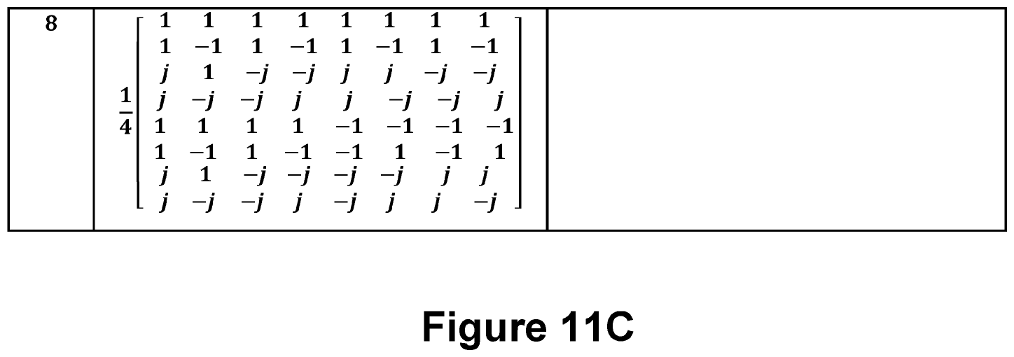

FIGS. 11A-11C show an example of the 8-layer precoder for 8 antenna ports.

In an embodiment, for rank-x (x=5, 7) with 8 antenna ports, the precoders could be generated by dropping some column of the precoders for rank-(x+1) with 8 antenna ports.

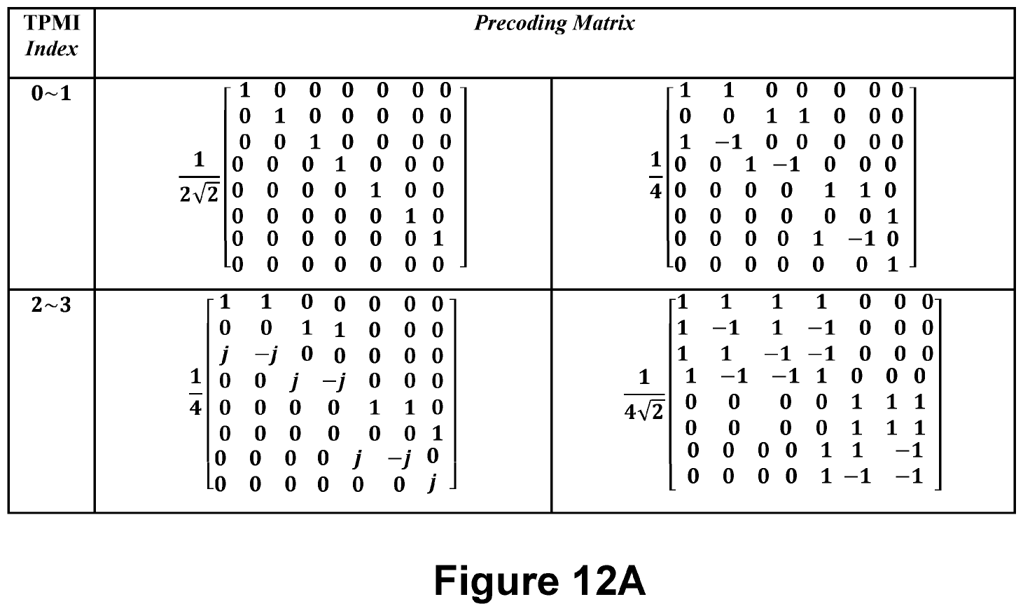

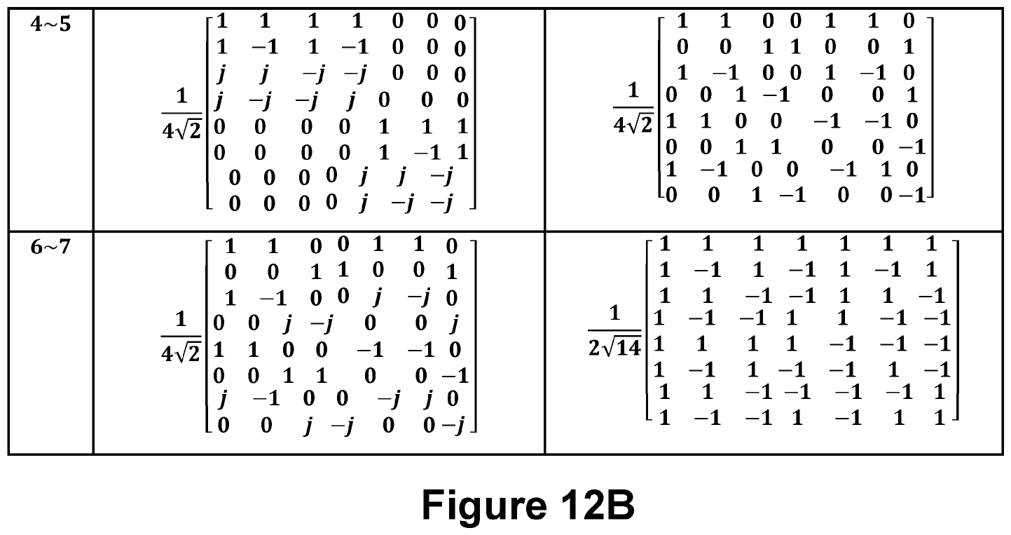

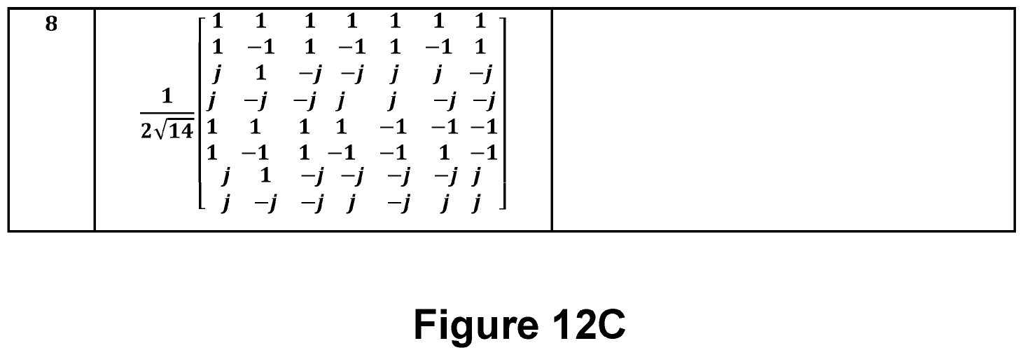

FIGS. 12A-12C show an example of a 7-layer precoder for 8 antenna ports.

In another embodiment, for partial coherent TPMIs, the coherent antenna ports could be up to UE antenna and RF architecture. For the 8-Tx UE, if the UE has two oscillators, then four ports are coherent. If the UE has four oscillators, then two ports are coherent. Whether two-port coherence or four-port coherence is supported could be reported by the UE.

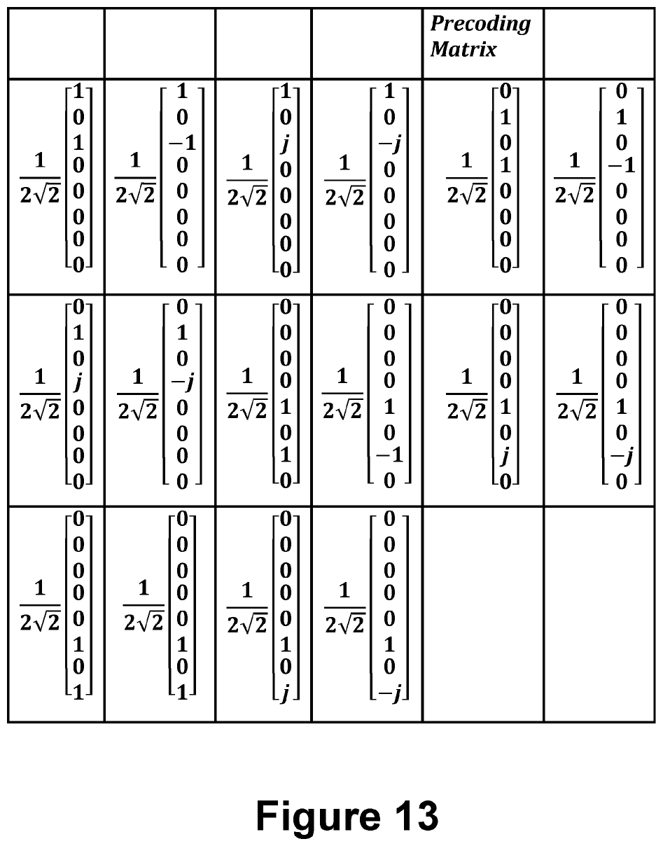

For example for 8-Tx UE, if the UE has four oscillators, then an example of the Rank-1 partial coherent TPMI codebook is shown in FIG. 13.

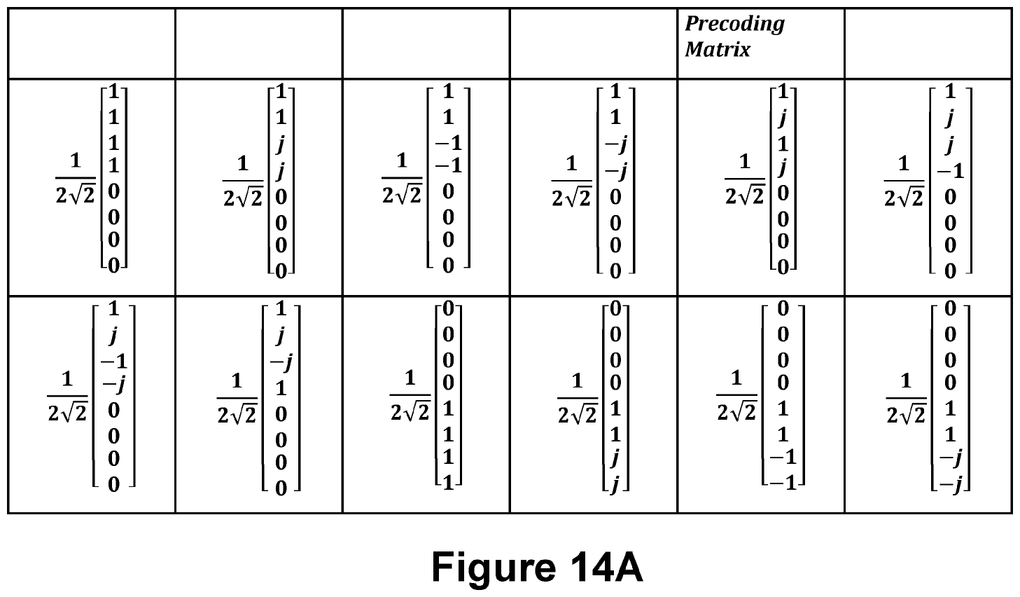

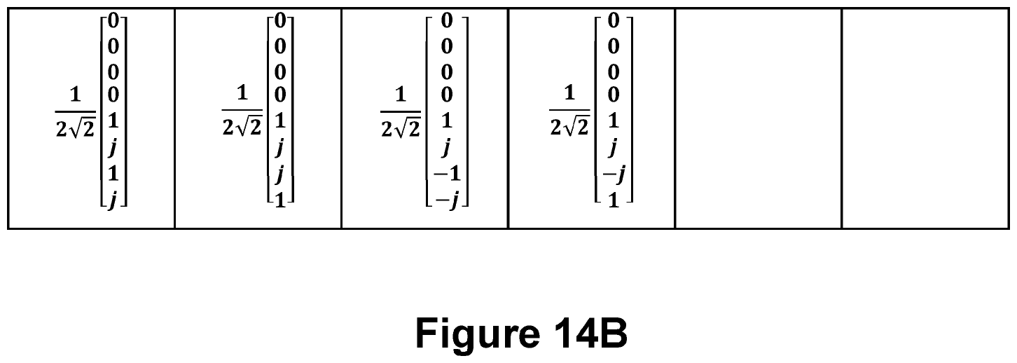

For 8-Tx UE, if the UE has two oscillators, then an example of the Rank-1 partial coherent TPMI codebook is shown in FIG. 14.

Note: All the embodiments described herein may also be applied to simultaneous transmission from multiple UE antenna panels. All the embodiments could be applied to codebook based uplink transmission. All the embodiments except TPMI-related aspects may be applied to non-codebook based uplink transmission.

All the embodiments described herein may be applied to CP-OFDM waveform and/or DFT-s-OFDM waveform. The multi-TRP operation described herein may be single-DCI multi-TRP operation or multi-DCI multi-TRP operation.

Frequency Selective Precoding for Uplink Transmission

In 5G NR Rel-15 to Rel-17 specifications, the frequency selective precoding could be applied for downlink transmission, e.g., the same precoding could be applied for some consecutive PRBs (Physical Resource Block) within the allocated bandwidth. The UE could be configured with PRG (Precoding Resource Block Group) size of {2, 4, wideband}. With the PRG size of 2 or 4, it means the same precoding is applied for every 2 or 4 consecutive PRBs. With the PRG value of wideband, it means the same precoding is applied over the entire allocated frequency band.

In NR Rel-18, in order to improve the uplink performance, the frequency selective precoding may be introduced for uplink transmission.

In NR, two transmission schemes are supported for PUSCH, codebook based transmission and non-codebook based transmission.

For codebook based transmission, the UE is configured with one SRS resource set consisting of one or multiple SRS resources. The ‘usage’ of the SRS resource set is set to ‘codebook’. The UE needs to send SRS resources to the gNB for link adaptation and the SRS is not precoded. After gNB measures the SRS resources, the gNB could send DCI including uplink grant to schedule PUSCH transmission. In the uplink grant, the TPMI (Transmission Precoding Matrix Index) and SRI (SRS Resource Indicator) are included. In the corresponding PUSCH transmission, the UE should apply the precoder as indicated by TPMI. The number of antenna ports for PUSCH transmission is the same as the SRS resource indicated by SRI. In FR2 (Frequency Range), the PUSCH transmission should also use the same spatial relation (same beam) as the SRS resource indicated by the SRI.

For non-codebook based transmission, the UE is configured with one SRS resource set consisting of one or multiple SRS resources. The ‘usage’ of the SRS resource set is set to ‘nonCodebook’. And all the SRS resources are configured with only one antenna port. For non-codebook based transmission, the UE could be configured with one NZP (non zero power) CSI-RS resource associated with the SRS resource set. Based on measuring on the CSI-RS resource, the UE could calculate the precoder used for SRS transmission, e.g., for non-codebook based transmission, the SRS resources transmission for link adaptation is precoded. After measuring the SRS, the gNB could indicate one or several SRIs for PUSCH transmission. The UE should select the precoder for PUSCH according to the indicated SRIs. In FR2, the spatial relation for PUSCH transmission could be based on either SRI or the measurement on CSI-RS.

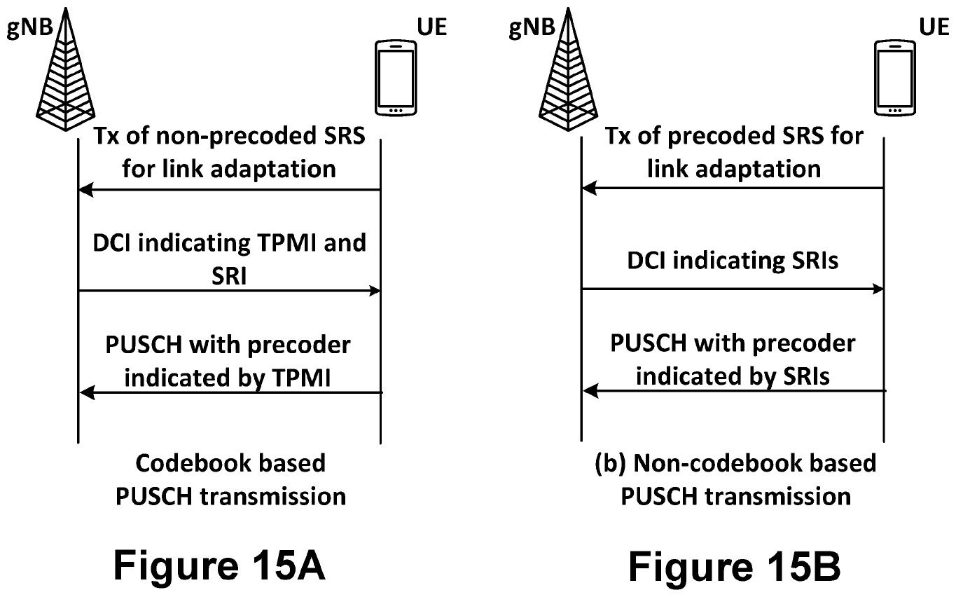

FIGS. 15A and 15B show the operation of codebook based and non-codebook based PUSCH transmission, respectively.

When frequency selective precoding is introduced for PUSCH, the codebook and non-codebook based transmission may be correspondingly enhanced. For example, multiple TPMIs and multiple SRIs may be included in the DCI to indicate the precoder for each PRG.

The current PUSCH transmission in NR doesn't support frequency selective precoding.

Various embodiments herein provide techniques for frequency selective precoding for PUSCH, including enhancements for codebook based transmission and non-codebook based transmission.

Frequency Selective Precoding for PUSCH

In an embodiment, frequency selective precoding is introduced for PUSCH transmission. The allocated frequency bandwidth for PUSCH could be split into several PRGs (Precoding resource block group), and each PRG consists of one or multiple consecutive PRBs. The same precoding, and the same Tx beam/spatial relation (if applicable in FR2, for example, the UE can support simultaneous transmission over multiple antenna panels) should be applied for the PRBs within one PRG, while the precoding and Tx beam/spatial relation could be different across different PRGs. Or the same precoding is applied to the PRBs within one PRG, while the same Tx beam/spatial relation is applied to all the PRBs of the entire allocated frequency bandwidth.

The PRG configuration for PUSCH could be configured by RRC/MAC-CE or indicated by DCI.

In one example, the UE could be configured with the value of PRGs for PUSCH, N_{PRG}, which indicates the number of PRGs within the allocated frequency bandwidth. The value of N_{PRG} could be one of {X₁, X₂, . . . , Xₙ}. In one example, the value of N_{PRG} could be one of {1, 2, 4}. The value of 1 means only one PRG, e.g., the PRG size equals to the entire allocated bandwidth. The value of 2 means there are two PRGs, the PRG size equals to half of the allocated bandwidth. The value of 4 means there are four PRGs, the PRG size equals to one fourth of the allocated bandwidth.

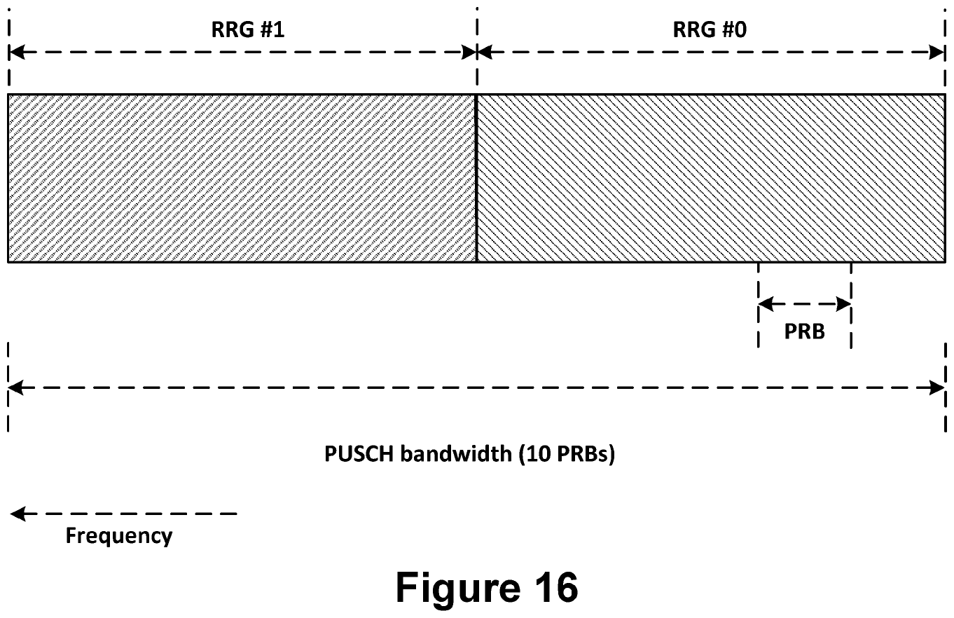

FIG. 16 shows an example of the operation. In the example, the allocated bandwidth for PUSCH is 10 PRBs and is split two PRGs. Each PRG consists of 5 consecutive PRBs. In another example, the value of N_{PRG} indicates the number of consecutive PRBs within one PRG.

Codebook Based PUSCH Transmission Enhancement

In an embodiment, for codebook based transmission, if frequency selective precoding is supported for PUSCH, then the one or multiple TPMIs should be indicated in the DCI scheduling PUSCH. If the number of PRGs for PUSCH is K (K>=1), then K (K>=1) TPMIs should be indicated in the DCI scheduling PUSCH.

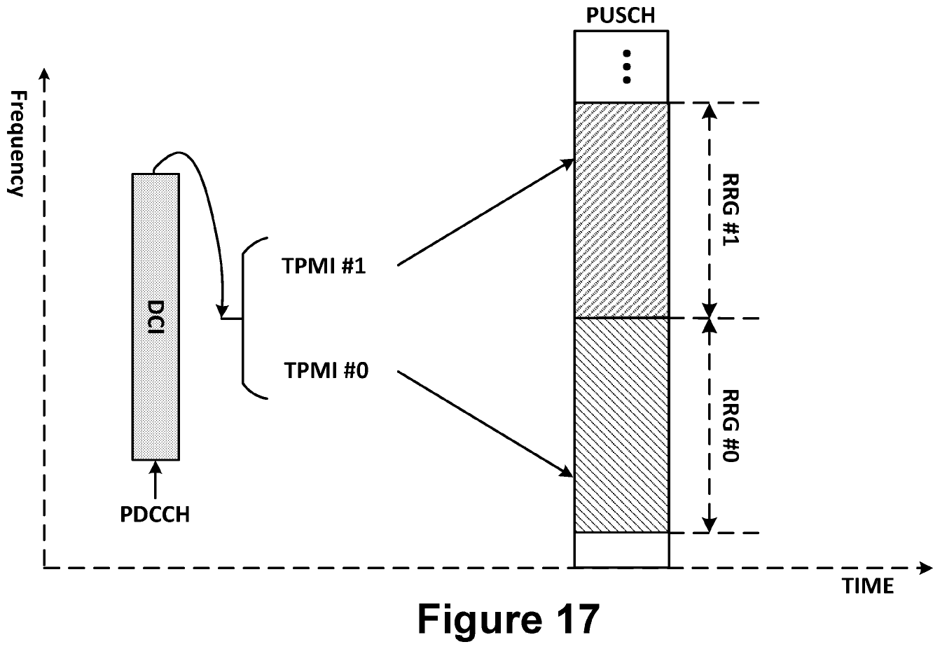

FIG. 17 shows an example of the operation with 2 PRGs configured and 2 TPMIs indicated in DCI.

In another embodiment, if frequency selective precoding for PUSCH is supported, only one SRS resource set is configured for codebook based transmission. Additionally, only one SRI is indicated in the DCI for codebook based PUSCH transmission. In this case, the same Tx beam indicated by the SRI should be applied for all the PRGs.

In another embodiment, if frequency selective precoding for PUSCH is supported, multiple SRS resource sets could be configured for codebook based transmission, and multiple SRI could be indicated in the DCI. Each SRI indicates one SRS resource in each SRS resource set respectively. For example, if the UE is configured with K (K>=1) PRGs, then the UE should be configured with K SRS resource sets, and K SRIs will be indicated in DCI. For the transmission of Ki-th (Ki<=K) PRG, the same beam as indicated by Ki-th SRI should be applied.

In another example, only one SRS resource set is configured for codebook based transmission, while multiple SRS resources are included in the SRS resource set, and multiple SRIs could be indicated in the DCI. For example, if the UE is configured with K (K>=1) PRGs, then the SRS resource set be configured with K SRS resources, and K SRIs will be indicated in DCI. For the transmission of Ki-th (Ki<=K) PRG, the same beam as indicated by Ki-th SRI should be applied.

In another embodiment, for codebook based transmission, the rank for each PRG could be the same or different if frequency selective precoding is enabled.

Non-Codebook Based PUSCH Transmission Enhancement

In an embodiment, for non-codebook based transmission, if frequency selective precoding is supported for PUSCH, then the one or multiple SRI fields should be indicated in the DCI scheduling PUSCH. If the number of PRGs for PUSCH is K (K>=1), then K (K>=1) SRI fields should be indicated in the DCI scheduling PUSCH. The Ki-th SRI field indicates the SRIs used for the Ki-th PRG transmission.

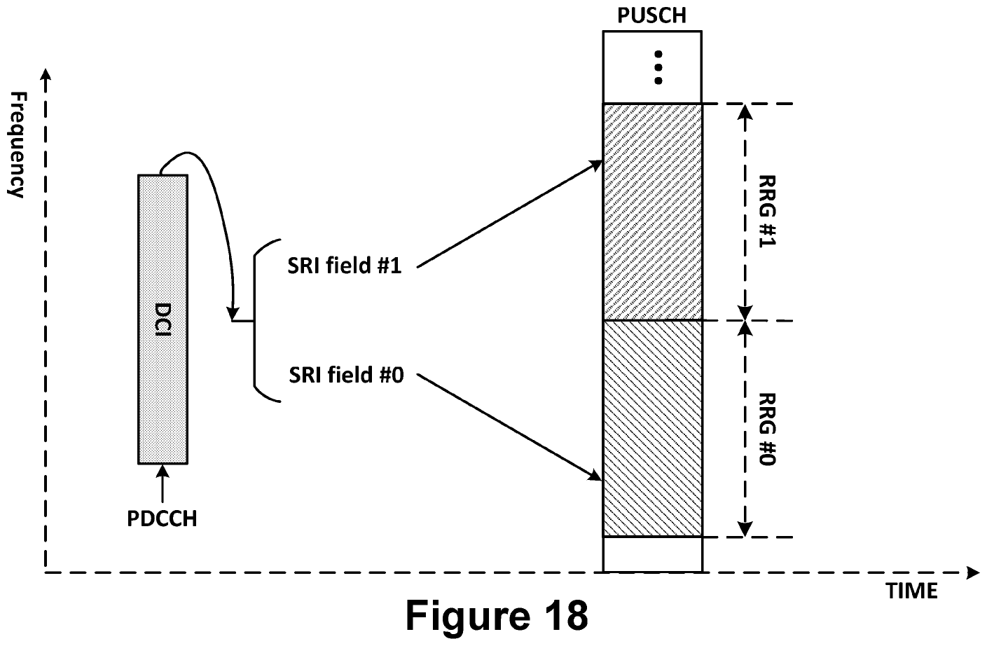

FIG. 18 shows an example of the operation with 2 PRGs configured and 2 SRIs indicated in DCI.

In another embodiment, if frequency selective precoding for PUSCH is supported, multiple SRS resource sets could be configured for non-codebook based transmission, and multiple SRI fields could be indicated in the DCI. Each SRS resource set is used to determine the precoding for a corresponding PRG.

For example, if the UE is configured with K (K>=1) PRGs, then the UE should be configured with K SRS resource sets for non-codebook based transmission, and K SRI fields will be indicated in DCI. The Ki-th SRI field indicates SRIs corresponding to the Ki-th SRS resource set. For the transmission of Ki-th (Ki<=K) PRG, the precoding information is indicated by the ki-th SRI field. The SRS resources in Ki-th SRS resource set will be transmitted over the bandwidth corresponding to the Ki-th PRG.

In another example, only one SRS resource set is configured for non-codebook based transmission, while multiple SRS resources are included in the SRS resource set. The SRS resources in the SRS resource set is split into multiple groups, each group corresponding to one PRG. If the UE is configured with K (K>=1) PRGs, then the UE should be configured one SRS resource sets and the SRS resources are split into K SRS resource groups, and K SRI fields will be indicated in DCI. The Ki-th SRI field indicates SRIs corresponding to the Ki-th SRS resource group. For the transmission of Ki-th (Ki<=K) PRG, the precoding information is indicated by the ki-th SRI field. The SRS resources in Ki-th SRS resource group will be transmitted over the bandwidth corresponding to the Ki-th PRG.

In another embodiment, if frequency selective precoding for PUSCH is supported, only one SRS resource set is configured for non-codebook based transmission, and the number of SRS resources in the SRS resource set is the same as the case that frequency selective precoding is not supported. In this case, the similar PRG will be applied for SRS transmission bandwidth. For example, the SRS transmission bandwidth is split into two frequency resource groups, and different precoding could be applied for the same SRS resource over different frequency resource group.

For example, if the UE is configured with K (K>=1) PRGs, then the UE should be configured with one SRS resource sets for non-codebook based transmission, and K SRI fields will be indicated in DCI. The SRS resource transmission bandwidth will be split into K frequency resource groups. And different precoding could be applied for different frequency resource group. For the transmission of Ki-th (Ki<=K) PRG of PUSCH, the precoding information is indicated by the ki-th SRI field.

In another embodiment, for non-codebook based transmission, the rank for each PRG could be the same or different if frequency selective precoding is enabled.

DFT-Based Codebook

In an embodiment, the codebook could be based on DFT based with two stage structure, for example, W=W₁·W₂. W₁ represents the wideband channel information, and W₂ represents the sub-band channel information. In one example, W₁ could be vector/matrix based on DFT operation, and W₂ could be the coefficients.

Note: all the embodiments in this disclosure may be applied to single TRP operation and multi-TRP operation. All the embodiments in this disclosure may be applied to single panel UE and multi-panel UE.

### Systems and Implementations

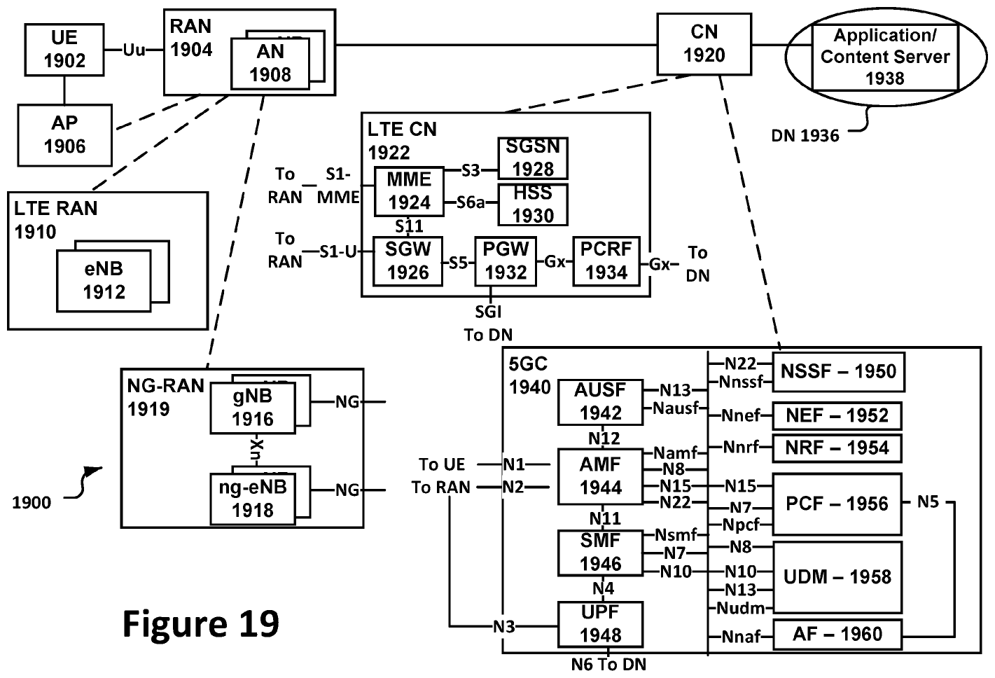

FIGS. 19-21 illustrate various systems, devices, and components that may implement aspects of disclosed embodiments.

FIG. 19 illustrates a network 1900 in accordance with various embodiments. The network 1900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1900 may include a UE 1902, which may include any mobile or non-mobile computing device designed to communicate with a RAN 1904 via an over-the-air connection. The UE 1902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1902 may additionally communicate with an AP 1906 via an over-the-air connection. The AP 1906 may manage a WLAN connection, which may serve to offload some/all network traffic from the RAN 1904. The connection between the UE 1902 and the AP 1906 may be consistent with any IEEE 802.11 protocol, wherein the AP 1906 could be a wireless fidelity (Wi-Fi®) router. In some embodiments, the UE 1902, RAN 1904, and AP 1906 may utilize cellular-WLAN aggregation (for example, LWA/LWIP). Cellular-WLAN aggregation may involve the UE 1902 being configured by the RAN 1904 to utilize both cellular radio resources and WLAN resources.

The RAN 1904 may include one or more access nodes, for example, AN 1908. AN 1908 may terminate air-interface protocols for the UE 1902 by providing access stratum protocols including RRC, PDCP, RLC, MAC, and L1 protocols. In this manner, the AN 1908 may enable data/voice connectivity between CN 1920 and the UE 1902. In some embodiments, the AN 1908 may be implemented in a discrete device or as one or more software entities running on server computers as part of, for example, a virtual network, which may be referred to as a CRAN or virtual baseband unit pool. The AN 1908 be referred to as a BS, gNB, RAN node, eNB, ng-eNB, NodeB, RSU, TRxP, TRP, etc. The AN 1908 may be a macrocell base station or a low power base station for providing femtocells, picocells or other like cells having smaller coverage areas, smaller user capacity, or higher bandwidth compared to macrocells.

In embodiments in which the RAN 1904 includes a plurality of ANs, they may be coupled with one another via an X2 interface (if the RAN 1904 is an LTE RAN) or an Xn interface (if the RAN 1904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1904 may each manage one or more cells, cell groups, component carriers, etc. to provide the UE 1902 with an air interface for network access. The UE 1902 may be simultaneously connected with a plurality of cells provided by the same or different ANs of the RAN 1904. For example, the UE 1902 and RAN 1904 may use carrier aggregation to allow the UE 1902 to connect with a plurality of component carriers, each corresponding to a Pcell or Scell.

In dual connectivity scenarios, a first AN may be a master node that provides an MCG and a second AN may be secondary node that provides an SCG. The first/second ANs may be any combination of eNB, gNB, ng-eNB, etc.

The RAN 1904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1902 or AN 1908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1904 may be an LTE RAN 1910 with eNBs, for example, eNB 1912. The LTE RAN 1910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1904 may be an NG-RAN 1914 with gNBs, for example, gNB 1916, or ng-eNBs, for example, ng-eNB 1918. The gNB 1916 may connect with 5G-enabled UEs using a 5G NR interface. The gNB 1916 may connect with a 5G core through an NG interface, which may include an N2 interface or an N3 interface. The ng-eNB 1918 may also connect with the 5G core through an NG interface, but may connect with a UE via an LTE air interface. The gNB 1916 and the ng-eNB 1918 may connect with each other over an Xn interface.

In some embodiments, the NG interface may be split into two parts, an NG user plane (NG-U) interface, which carries traffic data between the nodes of the NG-RAN 1914 and a UPF 1948 (e.g., N3 interface), and an NG control plane (NG-C) interface, which is a signaling interface between the nodes of the NG-RAN 1914 and an AMF 1944 (e.g., N2 interface).

The NG-RAN 1914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1902 can be configured with multiple BWPs where each BWP configuration has a different SCS. When a BWP change is indicated to the UE 1902, the SCS of the transmission is changed as well. Another use case example of BWP is related to power saving. In particular, multiple BWPs can be configured for the UE 1902 with different amount of frequency resources (for example, PRBs) to support data transmission under different traffic loading scenarios. A BWP containing a smaller number of PRBs can be used for data transmission with small traffic load while allowing power saving at the UE 1902 and in some cases at the gNB 1916. A BWP containing a larger number of PRBs can be used for scenarios with higher traffic load.

The RAN 1904 is communicatively coupled to CN 1920 that includes network elements to provide various functions to support data and telecommunications services to customers/subscribers (for example, users of UE 1902). The components of the CN 1920 may be implemented in one physical node or separate physical nodes. In some embodiments, NFV may be utilized to virtualize any or all of the functions provided by the network elements of the CN 1920 onto physical compute/storage resources in servers, switches, etc. A logical instantiation of the CN 1920 may be referred to as a network slice, and a logical instantiation of a portion of the CN 1920 may be referred to as a network sub-slice.

In some embodiments, the CN 1920 may be an LTE CN 1922, which may also be referred to as an EPC. The LTE CN 1922 may include MME 1924, SGW 1926, SGSN 1928, HSS 1930, PGW 1932, and PCRF 1934 coupled with one another over interfaces (or “reference points”) as shown. Functions of the elements of the LTE CN 1922 may be briefly introduced as follows.

The MME 1924 may implement mobility management functions to track a current location of the UE 1902 to facilitate paging, bearer activation/deactivation, handovers, gateway selection, authentication, etc.

The SGW 1926 may terminate an S1 interface toward the RAN and route data packets between the RAN and the LTE CN 1922. The SGW 1926 may be a local mobility anchor point for inter-RAN node handovers and also may provide an anchor for inter-3GPP mobility. Other responsibilities may include lawful intercept, charging, and some policy enforcement.

The SGSN 1928 may track a location of the UE 1902 and perform security functions and access control. In addition, the SGSN 1928 may perform inter-EPC node signaling for mobility between different RAT networks; PDN and S-GW selection as specified by MME 1924; MME selection for handovers; etc. The S3 reference point between the MME 1924 and the SGSN 1928 may enable user and bearer information exchange for inter-3GPP access network mobility in idle/active states.

The HSS 1930 may include a database for network users, including subscription-related information to support the network entities' handling of communication sessions. The HSS 1930 can provide support for routing/roaming, authentication, authorization, naming/addressing resolution, location dependencies, etc. An S6a reference point between the HSS 1930 and the MME 1924 may enable transfer of subscription and authentication data for authenticating/authorizing user access to the LTE CN 1920.

The PGW 1932 may terminate an SGi interface toward a data network (DN) 1936 that may include an application/content server 1938. The PGW 1932 may route data packets between the LTE CN 1922 and the data network 1936. The PGW 1932 may be coupled with the SGW 1926 by an S5 reference point to facilitate user plane tunneling and tunnel management. The PGW 1932 may further include a node for policy enforcement and charging data collection (for example, PCEF). Additionally, the SGi reference point between the PGW 1932 and the data network 19 36 may be an operator external public, a private PDN, or an intra-operator packet data network, for example, for provision of IMS services. The PGW 1932 may be coupled with a PCRF 1934 via a Gx reference point.

The PCRF 1934 is the policy and charging control element of the LTE CN 1922. The PCRF 1934 may be communicatively coupled to the app/content server 1938 to determine appropriate QoS and charging parameters for service flows. The PCRF 1932 may provision associated rules into a PCEF (via Gx reference point) with appropriate TFT and QCI.

In some embodiments, the CN 1920 may be a 5GC 1940. The 5GC 1940 may include an AUSF 1942, AMF 1944, SMF 1946, UPF 1948, NSSF 1950, NEF 1952, NRF 1954, PCF 1956, UDM 1958, and AF 1960 coupled with one another over interfaces (or “reference points”) as shown. Functions of the elements of the 5GC 1940 may be briefly introduced as follows.

The AUSF 1942 may store data for authentication of UE 1902 and handle authentication-related functionality. The AUSF 1942 may facilitate a common authentication framework for various access types. In addition to communicating with other elements of the 5GC 1940 over reference points as shown, the AUSF 1942 may exhibit an Nausf service-based interface.

The AMF 1944 may allow other functions of the 5GC 1940 to communicate with the UE 1902 and the RAN 1904 and to subscribe to notifications about mobility events with respect to the UE 1902. The AMF 1944 may be responsible for registration management (for example, for registering UE 1902), connection management, reachability management, mobility management, lawful interception of AMF-related events, and access authentication and authorization. The AMF 1944 may provide transport for SM messages between the UE 1902 and the SMF 1946, and act as a transparent proxy for routing SM messages. AMF 1944 may also provide transport for SMS messages between UE 1902 and an SMSF. AMF 1944 may interact with the AUSF 1942 and the UE 1902 to perform various security anchor and context management functions. Furthermore, A M F 1944 may be a termination point of a RAN CP interface, which may include or be an N2 reference point between the RAN 1904 and the AMF 1944; and the AMF 1944 may be a termination point of NAS (N1) signaling, and perform NAS ciphering and integrity protection. AMF 1944 may also support NAS signaling with the UE 1902 over an N3 IWF interface.

The SMF 1946 may be responsible for SM (for example, session establishment, tunnel management between UPF 1948 and AN 1908); UE IP address allocation and management (including optional authorization); selection and control of UP function; configuring traffic steering at UPF 1948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1944 over N2 to AN 1908; and determining SSC mode of a session. SM may refer to management of a PDU session, and a PDU session or “session” may refer to a PDU connectivity service that provides or enables the exchange of PDUs between the UE 1902 and the data network 1936.

The UPF 1948 may act as an anchor point for intra-RAT and inter-RAT mobility, an external PDU session point of interconnect to data network 1936, and a branching point to support multi-homed PDU session. The UPF 1948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1948 may include an uplink classifier to support routing traffic flows to a data network.

The NSSF 1950 may select a set of network slice instances serving the UE 1902. The NSSF 1950 may also determine allowed NSSAI and the mapping to the subscribed S-NSSAIs, if needed. The NSSF 1950 may also determine the AMF set to be used to serve the UE 1902, or a list of candidate AMFs based on a suitable configuration and possibly by querying the NRF 1954.

The selection of a set of network slice instances for the UE 1902 may be triggered by the AMF 1944 with which the UE 1902 is registered by interacting with the NSSF 1950, which may lead to a change of AMF. The NSSF 1950 may interact with the AMF 1944 via an N22 reference point; and may communicate with another NSSF in a visited network via an N31 reference point (not shown). Additionally, the NSSF 1950 may exhibit an Nnssf service-based interface.

The NEF 1952 may securely expose services and capabilities provided by 3GPP network functions for third party, internal exposure/re-exposure, AFs (e.g., AF 1960), edge computing or fog computing systems, etc. In such embodiments, the NEF 1952 may authenticate, authorize, or throttle the AFs. NEF 1952 may also translate information exchanged with the AF 1960 and information exchanged with internal network functions. For example, the NEF 1952 may translate between an AF-Service-Identifier and an internal 5GC information. NEF 1952 may also receive information from other NFs based on exposed capabilities of other NFs. This information may be stored at the NEF 1952 as structured data, or at a data storage NF using standardized interfaces. The stored information can then be re-exposed by the NEF 1952 to other NFs and AFs, or used for other purposes such as analytics. Additionally, the NEF 1952 may exhibit an Nnef service-based interface.

The NRF 1954 may support service discovery functions, receive NF discovery requests from NF instances, and provide the information of the discovered NF instances to the NF instances. NRF 1954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1954 may exhibit the Nnrf service-based interface.

The PCF 1956 may provide policy rules to control plane functions to enforce them, and may also support unified policy framework to govern network behavior. The PCF 1956 may also implement a front end to access subscription information relevant for policy decisions in a UDR of the UDM 1958. In addition to communicating with functions over reference points as shown, the PCF 1956 exhibit an Npcf service-based interface.

The UDM 1958 may handle subscription-related information to support the network entities' handling of communication sessions, and may store subscription data of UE 1902. For example, subscription data may be communicated via an N8 reference point between the UDM 1958 and the AMF 1944. The UDM 1958 may include two parts, an application front end and a UDR. The UDR may store subscription data and policy data for the UDM 1958 and the PCF 1956, and/or structured data for exposure and application data (including PFDs for application detection, application request information for multiple UEs 1902) for the NEF 1952. The Nudr service-based interface may be exhibited by the UDR 221 to allow the UDM 1958, PCF 1956, and NEF 1952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1958 may exhibit the Nudm service-based interface.

The AF 1960 may provide application influence on traffic routing, provide access to NEF, and interact with the policy framework for policy control.

In some embodiments, the 5GC 1940 may enable edge computing by selecting operator/3^{rd} party services to be geographically close to a point that the UE 1902 is attached to the network. This may reduce latency and load on the network. To provide edge-computing implementations, the 5GC 1940 may select a UPF 1948 close to the UE 1902 and execute traffic steering from the UPF 1948 to data network 1936 via the N6 interface. This may be based on the UE subscription data, UE location, and information provided by the AF 1960. In this way, the AF 1960 may influence UPF (re)selection and traffic routing. Based on operator deployment, when AF 1960 is considered to be a trusted entity, the network operator may permit AF 1960 to interact directly with relevant NFs. Additionally, the AF 1960 may exhibit an Naf service-based interface.

The data network 1936 may represent various network operator services, Internet access, or third party services that may be provided by one or more servers including, for example, application/content server 1938.

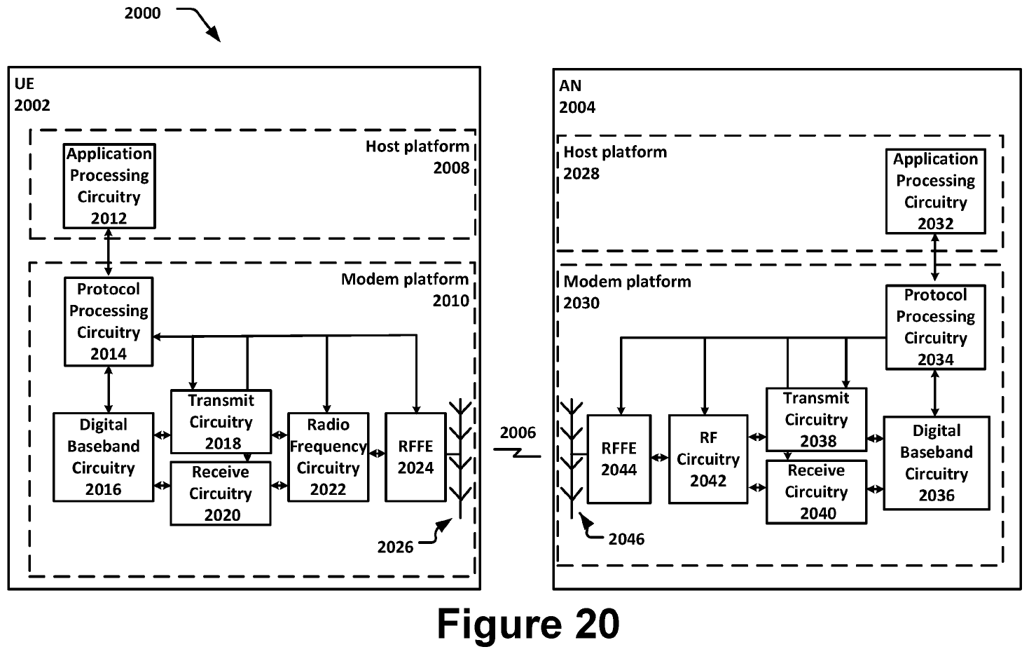

FIG. 20 schematically illustrates a wireless network 2000 in accordance with various embodiments. The wireless network 2000 may include a UE 2002 in wireless communication with an AN 2004. The UE 2002 and AN 2004 may be similar to, and substantially interchangeable with, like-named components described elsewhere herein.

The UE 2002 may be communicatively coupled with the AN 2004 via connection 2006. The connection 2006 is illustrated as an air interface to enable communicative coupling, and can be consistent with cellular communications protocols such as an LTE protocol or a 5G NR protocol operating at mmWave or sub-6 GHz frequencies.

The UE 2002 may include a host platform 2008 coupled with a modem platform 2010. The host platform 2008 may include application processing circuitry 2012, which may be coupled with protocol processing circuitry 2014 of the modem platform 2010. The application processing circuitry 2012 may run various applications for the UE 2002 that source/sink application data. The application processing circuitry 2012 may further implement one or more layer operations to transmit/receive application data to/from a data network. These layer operations may include transport (for example UDP) and Internet (for example, IP) operations

The protocol processing circuitry 2014 may implement one or more of layer operations to facilitate transmission or reception of data over the connection 2006. The layer operations implemented by the protocol processing circuitry 2014 may include, for example, MAC, RLC, PDCP, RRC and NAS operations.

The modem platform 2010 may further include digital baseband circuitry 2016 that may implement one or more layer operations that are “below” layer operations performed by the protocol processing circuitry 2014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 2010 may further include transmit circuitry 2018, receive circuitry 2020, RF circuitry 2022, and RF front end (RFFE) 2024, which may include or connect to one or more antenna panels 2026. Briefly, the transmit circuitry 2018 may include a digital-to-analog converter, mixer, intermediate frequency (IF) components, etc.; the receive circuitry 2020 may include an analog-to-digital converter, mixer, IF components, etc.; the RF circuitry 2022 may include a low-noise amplifier, a power amplifier, power tracking components, etc.; RFFE 2024 may include filters (for example, surface/bulk acoustic wave filters), switches, antenna tuners, beamforming components (for example, phase-array antenna components), etc. The selection and arrangement of the components of the transmit circuitry 2018, receive circuitry 2020, RF circuitry 2022, RFFE 2024, and antenna panels 2026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 2014 may include one or more instances of control circuitry (not shown) to provide control functions for the transmit/receive components.

A UE reception may be established by and via the antenna panels 2026, RFFE 2024, RF circuitry 2022, receive circuitry 2020, digital baseband circuitry 2016, and protocol processing circuitry 2014. In some embodiments, the antenna panels 2026 may receive a transmission from the AN 2004 by receive-beamforming signals received by a plurality of antennas/antenna elements of the one or more antenna panels 2026.

A UE transmission may be established by and via the protocol processing circuitry 2014, digital baseband circuitry 2016, transmit circuitry 2018, RF circuitry 2022, RFFE 2024, and antenna panels 2026. In some embodiments, the transmit components of the UE 2004 may apply a spatial filter to the data to be transmitted to form a transmit beam emitted by the antenna elements of the antenna panels 2026.

Similar to the UE 2002, the AN 2004 may include a host platform 2028 coupled with a modem platform 2030. The host platform 2028 may include application processing circuitry 2032 coupled with protocol processing circuitry 2034 of the modem platform 2030. The modem platform may further include digital baseband circuitry 2036, transmit circuitry 2038, receive circuitry 2040, RF circuitry 2042, RFFE circuitry 2044, and antenna panels 2046. The components of the AN 2004 may be similar to and substantially interchangeable with like-named components of the UE 2002. In addition to performing data transmission/reception as described above, the components of the AN 2008 may perform various logical functions that include, for example, RNC functions such as radio bearer management, uplink and downlink dynamic radio resource management, and data packet scheduling.

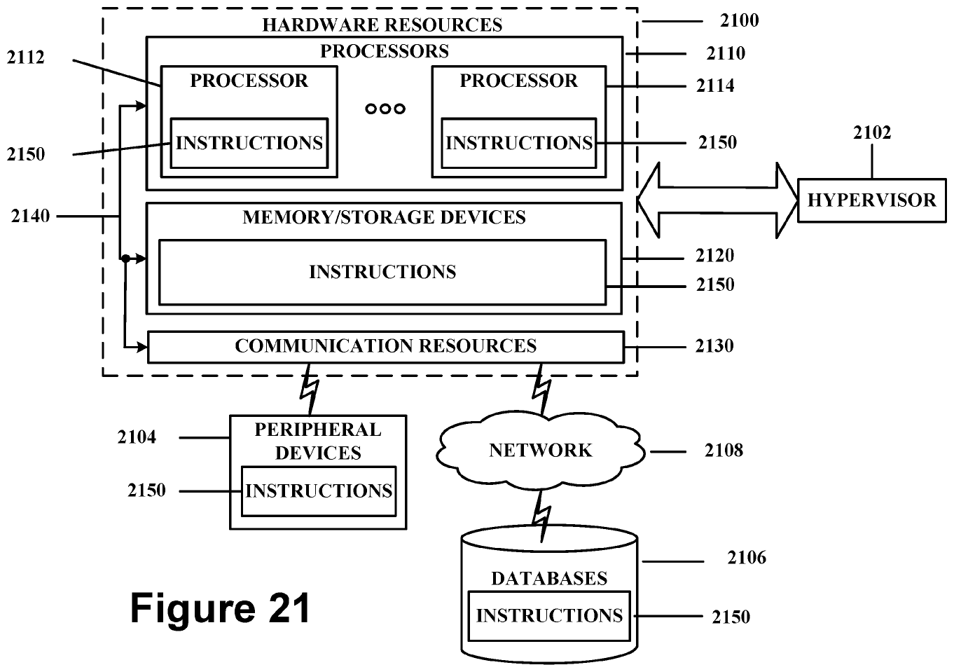

FIG. 21 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 21 shows a diagrammatic representation of hardware resources 2100 including one or more processors (or processor cores) 2110, one or more memory/storage devices 2120, and one or more communication resources 2130, each of which may be communicatively coupled via a bus 2140 or other interface circuitry. For embodiments where node virtualization (e.g., NFV) is utilized, a hypervisor 2102 may be executed to provide an execution environment for one or more network slices/sub-slices to utilize the hardware resources 2100.

The processors 2110 may include, for example, a processor 2112 and a processor 2114. The processors 2110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 2120 may include main memory, disk storage, or any suitable combination thereof. The memory/storage devices 2120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2130 may include interconnection or network interface controllers, components, or other suitable devices to communicate with one or more peripheral devices 2104 or one or more databases 2106 or other network elements via a network 2108. For example, the communication resources 2130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2150 may comprise software, a program, an application, an applet, an app, or other executable code for causing at least any of the processors 2110 to perform any one or more of the methodologies discussed herein. The instructions 2150 may reside, completely or partially, within at least one of the processors 2110 (e.g., within the processor's cache memory), the memory/storage devices 2120, or any suitable combination thereof. Furthermore, any portion of the instructions 2150 may be transferred to the hardware resources 2100 from any combination of the peripheral devices 2104 or the databases 2106. Accordingly, the memory of processors 2110, the memory/storage devices 2120, the peripheral devices 2104, and the databases 2106 are examples of computer-readable and machine-readable media.

### Example Procedures

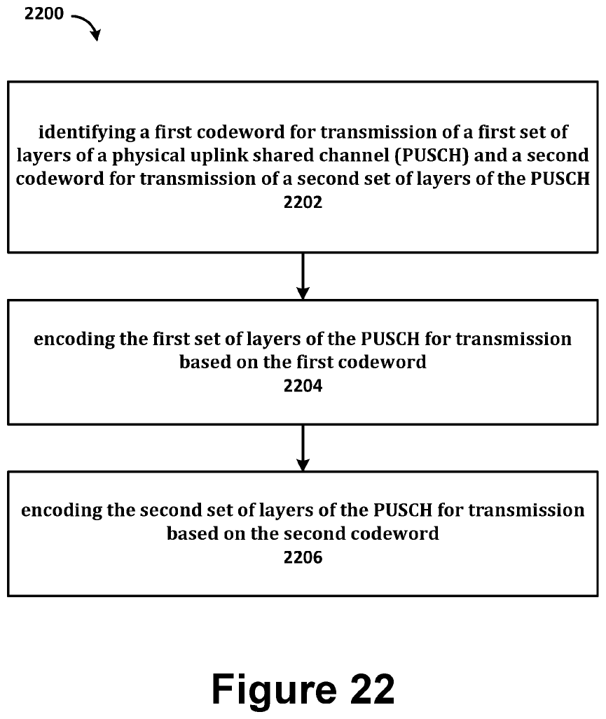

In some embodiments, the electronic device(s), network(s), system(s), chip(s) or component(s), or portions or implementations thereof, of FIGS. 19-21, or some other figure herein, may be configured to perform one or more processes, techniques, or methods as described herein, or portions thereof. One such process 2200 is depicted in FIG. 22. In some embodiments, the process 2200 may be performed by a UE or a portion thereof.

For example, the process may include, at 2202, identifying a first codeword for transmission of a first set of layers of a physical uplink shared channel (PUSCH) and a second codeword for transmission of a second set of layers of the PUSCH. At 2204, the process may further include encoding the first set of layers of the PUSCH for transmission based on the first codeword. At 2206, the process may further include encoding the second set of layers of the PUSCH for transmission based on the second codeword.

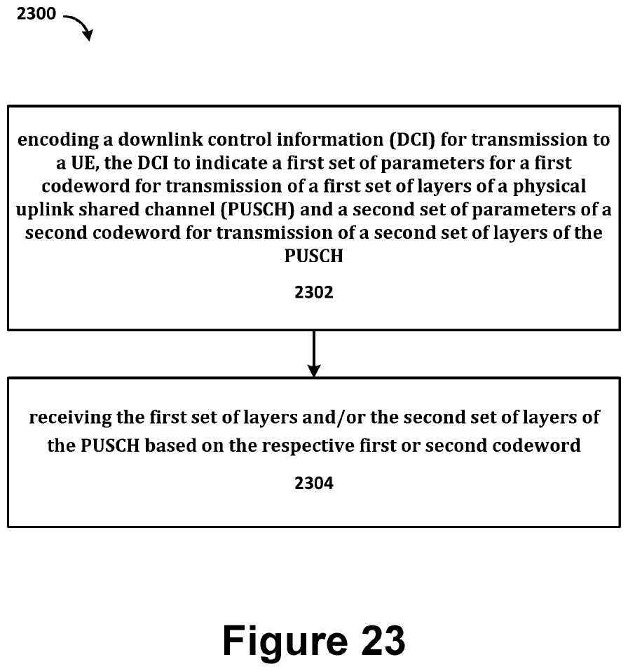

FIG. 23 illustrates another process 2300 in accordance with various embodiments. The process 2300 may be performed by a gNB or a portion thereof. At 2302, the process 2300 may include encoding a downlink control information (DCI) for transmission to a UE, the DCI to indicate a first set of parameters of a first codeword for transmission of a first set of layers of a physical uplink shared channel (PUSCH) and a second set of parameters of a second codeword for transmission of a second set of layers of the PUSCH. At 2304, the process may further include receiving the first set of layers and/or the second set of layers of the PUSCH based on the respective first or second codeword.

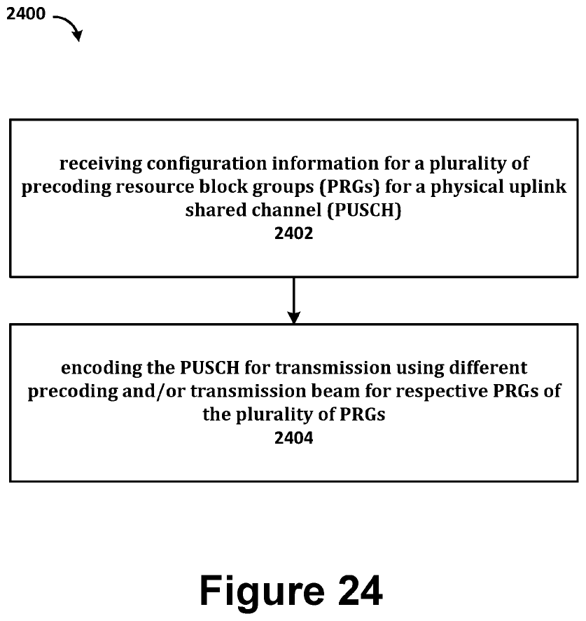

FIG. 24 illustrates another process 2400 in accordance with various embodiments. The process 2400 may be performed by a UE or a portion thereof. For example, the process 2400 may include, at 2402, receiving configuration information for a plurality of precoding resource block groups (PRGs) for a physical uplink shared channel (PUSCH). At 2404, the process 2400 may further include encoding the PUSCH for transmission using different precoding and/or transmission beam for respective PRGs of the plurality of PRGs.

In some embodiments, the PRGs may be differentiated in the frequency domain. For example, the PRGs may include one or more PRBs that are consecutive in the time domain.

In some embodiments, the configuration information may indicate a number of PRGs within a frequency bandwidth that is allocated for the PUSCH and/or a number of PRBs (e.g., consecutive PRBs) in the respective PRGs.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A1 may a method of a gNB or a UE, wherein the gNB configures the UE for uplink PUSCH transmission.

Example A2 may include the method of example A1 or some other example herein, wherein multiple codewords could be introduced for PUSCH, for example, two codewords, in order to enable more than four layers (e.g. 8 layers) uplink transmission. In one example, the first codeword could be mapped to layer 1 to layer 4, and the second codeword could be mapped to layer 5 to layer 8.

Example A3 may include the method of example A2 or some other example herein, wherein in the uplink DCI format 0_1/0_2 or any other DCI format which can schedules PUSCH transmission, the DCI format could include multiple following fields and the presence of the field for the second codeword could be configurable.

Multiple Modulation and Coding Scheme (MCS) fields, for example, two MCS fields. The first MCS field is applied to the first codeword, the second MCS field is applied to the second codeword.
Multiple New Data Indicator (NDI) fields, for example, two NDI fields. The first NDI field is applied to the first codeword, the second NDI field is applied to the second codeword.
Multiple Redundancy Version (RV) fields, for example, two RV fields. The first RV field is applied to the first codeword, the second RV field is applied to the second codeword.

Example A4 may include the method of example A2 or some other example herein, wherein for codebook based uplink transmission with multiple codewords, in the uplink DCI format 0_1/0_2 or any other DCI format which can schedules PUSCH transmission, the DCI format could include multiple Precoding Information and Number of Layers fields, e.g. two fields, to indicate the TPMI used for uplink transmission. The first Precoding Information and Number of Layers field is applied to the first codeword, the second Precoding Information and Number of Layers field is applied to the second codeword, e.g. the TPMIs are generated per codeword. The TPMIs could be extended to more than four layers (e.g. 8-port precoder) or kept as four layers (e.g. 4-port precoder). In one example, different MCS/rank and TPMIs could be applied for different codeword. In another example, the same MCS/rank and TPMIs could be applied for all the codewords.

Example A5 may include the method of example A2 or some other example herein, wherein the uplink transmission with multiple codewords could be applied for multi-TRP eMBB operation. For example, the first codeword is applied to the transmission toward the first TRP, and the second codeword is applied to the transmission toward the second TRP. Correspondingly, the multiple MCS/NDI/RV/TPMIs fields in the DCI would be applied for transmission toward different TRPs. The TPMIs could be extended to more than four layers or kept as four layers. In one example, different MCS/rank and TPMIs could be applied for different codeword/different TRP. In another example, the same MCS/rank and TPMIs could be applied for all the codewords/all the TRPs.

Example A6 may include the method of example A1 or some other example herein, wherein only one codeword is used for PUSCH to support more than four layers (e.g. 8 layers) uplink transmission. In this case, in the uplink DCI format 0_1/0_2 or any other DCI format which can schedules PUSCH transmission, the DCI format includes only one MCS/RV/NDI field and only one Precoding Information and Number of Layers field. Correspondingly, the TPMIs should be extended to more than four layers (e.g. 8-port precoder).

Example A7 may include the method of example A6 or some other example herein, wherein for rank-x (x is integer and 1≤x≤4) with 8 antenna ports, the precoders could be generated by the Kronecker product of rank-1 precoder with 2 ports and rank-x precoder with 4 ports.

Example A8 may include the method of example 6 or some other example herein, wherein for rank-x (x=6, 8) with 8 antenna ports, the precoders could be generated by the Kronecker product of rank-2 precoder with 2 ports and rank-(x/2) precoder with 4 ports.

Example A9 may include the method of example A6 or some other example herein, wherein for rank-x (x=5, 7) with 8 antenna ports, the precoders could be generated by dropping some column of the precoders for rank-(x+1) with 8 antenna ports.

Example A10 may include a method of a UE, the method comprising:
identifying a first codeword for transmission of a first set of layers of a physical uplink shared channel (PUSCH) and a second codeword for transmission of a second set of layers of the PUSCH;
encoding the first set of layers of the PUSCH for transmission based on the first codeword; and
encoding the second set of layers of the PUSCH for transmission based on the second codeword.

Example A11 may include the method of example A10 or some other example herein, wherein a total number of layers in the first and second sets of layers is greater than 4.

Example A12 may include the method of example A10-A11 or some other example herein, wherein the first and second sets of layers each include 4 layers.

Example A13 may include the method of example A10-A12 or some other example herein, further comprising receiving a DCI to indicate one or more parameters of the first codeword and one or more parameters of the second codeword.

Example A14 may include the method of example A13 or some other example herein, wherein the one or more parameters include one or more of a modulation and coding scheme (MCS), a new data indicator (NDI), a redundancy version, precoding information, or number of layers.

Example A15 may include the method of example A14 or some other example herein, wherein the DCI includes different fields for the one or more parameters of the first codeword and the one or more parameters of the second codeword.

Example A16 may include the method of example A13-A15 or some other example herein, wherein the DCI further indicates one or more parameters that are used for both the first and second codewords.

Example A17 may include the method of example A10-A16 or some other example herein, further comprising determining different transmission precoding matrix indicators (TPMIs) for the first and second codewords.

Example A18 may include the method of example A10-A17 or some other example herein, wherein the first set of layers are transmitted to a first transmission-reception point (TRP) and the second set of layers are transmitted to a second TRP.

Example A19 may include a method of a gNB, the method comprising:
encoding a downlink control information (DCI) for transmission to a UE, the DCI to indicate one or more parameters for a first codeword for transmission of a first set of layers of a physical uplink shared channel (PUSCH) and a second codeword for transmission of a second set of layers of the PUSCH; and
receiving the first set of layers and/or the second set of layers of the PUSCH based on the respective first or second codeword.

Example A20 may include the method of example A19 or some other example herein, wherein a total number of layers in the first and second sets of layers is greater than 4.

Example A21 may include the method of example A19-A20 or some other example herein, wherein the first and second sets of layers each include 4 layers.

Example A22 may include the method of example A19-A21 or some other example herein, wherein the one or more parameters include one or more of a modulation and coding scheme (MCS), a new data indicator (NDI), a redundancy version, precoding information, or number of layers.

Example A23 may include the method of example A22 or some other example herein, wherein the DCI includes different fields for the one or more parameters of the first codeword and the one or more parameters of the second codeword.

Example A24 may include the method of example A19-A23 or some other example herein, wherein the DCI indicates one or more parameters that are used for both the first and second codewords.

Example A25 may include the method of example A19-A24 or some other example herein, wherein the first and second sets of layers are associated with different transmission precoding matrix indicators (TPMIs).

Example A26 may include the method of example A19-A25 or some other example herein, wherein the first set of layers are transmitted to a first transmission-reception point (TRP) and the second set of layers are transmitted to a second TRP.

Example B1 may include a method of a gNB, wherein the gNB could configure and schedule the UE with uplink transmission over PUSCH. The PUSCH transmission could be codebook based or non-codebook based.

Example B2 may include the method of example B1 or some other example herein, wherein frequency selective precoding is introduced for PUSCH transmission. The allocated frequency bandwidth for PUSCH could be split into several PRGs (Precoding resource block group), and each PRG consists of one or multiple consecutive PRBs.

Example B3 may include the method of example B2 or some other example herein, wherein the same precoding, and the same Tx beam/spatial relation (if applicable in FR2, for example, the UE can support simultaneous transmission over multiple antenna panels) should be applied for the PRBs within one PRG, while the precoding and Tx beam/spatial relation could be different across different PRGs. Or the same precoding is applied to the PRBs within one PRG, while the same Tx beam/spatial relation is applied to all the PRBs of the entire allocated frequency bandwidth.

Example B4 may include the method of example B2 or some other example herein, wherein the PRG configuration for PUSCH could be configured by RRC/MAC-CE or indicated by DCI.

Example B5 may include the method of example B2 or some other example, wherein the UE could be configured with the value of PRGs for PUSCH, N_{PRG}. For example, a set of values of {X₁, X₂, . . . , Xₙ} could be configured by RRC, and DCI will indicate one value used for UE.

Example B6 may include the method of example B5 or some other example herein, wherein the value of N_{PRG} indicates the number of PRGs within the allocated frequency bandwidth. The value of 1 means only one PRG, e.g., the PRG size equals to the entire allocated bandwidth. The value of 2 means there are two PRGs, the PRG size equals to half of the allocated bandwidth. The value of 4 means there are four PRGs, the PRG size equals to one fourth of the allocated bandwidth.

Example B7 may include the method of example B5 or some other example herein, wherein the value of N_{PRG} indicates the number of consecutive PRBs within one PRG.

Example B8 may include the method of example B1, example B2, or some other example herein, wherein for codebook based transmission, if frequency selective precoding is supported for PUSCH, then the one or multiple TPMIs should be indicated in the DCI scheduling PUSCH. If the number of PRGs for PUSCH is K (K>=1), then K (K>=1) TPMIs should be indicated in the DCI scheduling PUSCH.

Example B9 may include the method of example B8 or some other example herein, wherein if frequency selective precoding for PUSCH is supported, only one SRS resource set is configured for codebook based transmission. And only one SRI is indicated in the DCI for codebook based PUSCH transmission. In this case, the same Tx beam indicated by the SRI should be applied for all the PRGs.

Example B10 may include the method of example B8 or some other example herein, wherein if frequency selective precoding for PUSCH is supported, multiple SRS resource sets could be configured for codebook based transmission, and multiple SRI could be indicated in the DCI. Each SRI indicates one SRS resource in each SRS resource set respectively. For example, if the UE is configured with K (K>=1) PRGs, then the UE should be configured with K SRS resource sets, and K SRIs will be indicated in DCI. For the transmission of Ki-th (Ki<=K) PRG, the same beam as indicated by Ki-th SRI should be applied.

Example B11 may include the method of example B8 or some other example herein, wherein only one SRS resource set is configured for codebook based transmission, while multiple SRS resources are included in the SRS resource set, and multiple SRIs could be indicated in the DCI. For example, if the UE is configured with K (K>=1) PRGs, then the SRS resource set be configured with K SRS resources, and K SRIs will be indicated in DCI. For the transmission of Ki-th (Ki<=K) PRG, the same beam as indicated by Ki-th SRI should be applied.

Example B12 may include the method of example B8 or some other example herein, wherein for codebook based transmission, the rank for each PRG could be the same or different if frequency selective precoding is enabled.

Example B13 may include the method of example B1, example B2, or some other example herein, wherein for non-codebook based transmission, if frequency selective precoding is supported for PUSCH, then the one or multiple SRI fields should be indicated in the DCI scheduling PUSCH. If the number of PRGs for PUSCH is K (K>=1), then K (K>=1) SRI fields should be indicated in the DCI scheduling PUSCH. The Ki-th SRI field indicates the SRIs used for the Ki-th PRG transmission.

Example B14 may include the method of example B13 or some other example herein, wherein if frequency selective precoding for PUSCH is supported, multiple SRS resource sets could be configured for non-codebook based transmission, and multiple SRI fields could be indicated in the DCI. Each SRS resource set is used to determine the precoding for a corresponding PRG. For example, if the UE is configured with K (K>=1) PRGs, then the UE should be configured with K SRS resource sets for non-codebook based transmission, and K SRI fields will be indicated in DCI. The Ki-th SRI field indicates SRIs corresponding to the Ki-th SRS resource set. For the transmission of Ki-th (Ki<=K) PRG, the precoding information is indicated by the ki-th SRI field. The SRS resources in Ki-th SRS resource set will be transmitted over the bandwidth corresponding to the Ki-th PRG.

Example B15 may include the method of example B13 or some other example herein, wherein only one SRS resource set is configured for non-codebook based transmission, while multiple SRS resources are included in the SRS resource set. The SRS resources in the SRS resource set is split into multiple groups, each group corresponding to one PRG. If the UE is configured with K (K>=1) PRGs, then the UE should be configured one SRS resource sets and the SRS resources are split into K SRS resource groups, and K SRI fields will be indicated in DCI. The Ki-th SRI field indicates SRIs corresponding to the Ki-th SRS resource group. For the transmission of Ki-th (Ki<=K) PRG, the precoding information is indicated by the ki-th SRI field. The SRS resources in Ki-th SRS resource group will be transmitted over the bandwidth corresponding to the Ki-th PRG.

Example B16 may include the method of example B13 or some other example herein, wherein if frequency selective precoding for PUSCH is supported, only one SRS resource set is configured for non-codebook based transmission, and the number of SRS resources in the SRS resource set is the same as the case that frequency selective precoding is not supported. In this case, the similar PRG will be applied for SRS transmission bandwidth. The SRS transmission bandwidth is split into two frequency resource groups, and different precoding could be applied for the same SRS resource over different frequency resource group. For example, if the UE is configured with K (K>=1) PRGs, then the UE should be configured with one SRS resource sets for non-codebook based transmission, and K SRI fields will be indicated in DCI. The SRS resource transmission bandwidth will be split into K frequency resource groups. And different precoding could be applied for different frequency resource group. For the transmission of Ki-th (Ki<=K) PRG of PUSCH, the precoding information is indicated by the ki-th SRI field.

Example B17 may include the method of example B13 or some other example herein, wherein for non-codebook based transmission, the rank for each PRG could be the same or different if frequency selective precoding is enabled.

Example B18 may include the method of example B1, example B2, or some other example herein, wherein the codebook could be based on DFT based with two stage structure, for example, W=W₁·W₂. W₁ represents the wideband channel information, and W₂ represents the sub-band channel information. In one example, W₁ could be vector/matrix based on DFT operation, and W₂ could be the coefficients.

Example B19 may include a method of a UE, the method comprising:
receiving configuration information for a plurality of precoding resource block groups (PRGs) for a physical uplink shared channel (PUSCH); and
encoding the PUSCH for transmission using different precoding and/or transmission beam for respective PRGs of the plurality of PRGs.

Example B20 may include the method of example B19 or some other example herein, wherein the PUSCH is codebook-based or non-codebook-based.

Example B21 may include the method of example B19-B20 or some other example herein, wherein the PRGs are differentiated in the frequency domain.

Example B22 may include the method of example B19-B21 or some other example herein, wherein individual PRGs of the plurality of PRGs include a plurality of physical resource blocks (PRBs) that are consecutive in the time domain.

Example B23 may include the method of example B19-B22 or some other example herein, wherein the different PRGs are encoded using different precoding and different transmission beams.

Example B24 may include the method of example B19-B22 or some other example herein, wherein the different PRGs are encoded using different precoding and the same transmission beam.

Example B25 may include the method of example B19-B24 or some other example herein, wherein the configuration information is received via radio resource control (RRC) signaling.

Example B26 may include the method of example B19-B25 or some other example herein, wherein the configuration information is indicated by a downlink control information (DCI).

Example B27 may include the method of example B19-B25 or some other example herein, wherein the configuration information includes an indicator, N_{PRG}, of a number of PRGs within an allocated frequency bandwidth of the PUSCH.

Example B28 may include the method of example B27, further comprising receiving configuration information for a plurality of N_{PRG} values; and receiving (e.g., via DCI) an indication of a selected one of the N_{PRG} values to use.

Example B29 may include the method of example B19-B28 or some other example herein, wherein the configuration information indicates a number of PRBs included within one PRG.

Example B30 may include the method of example B19-B29 or some other example herein, further comprising receiving a DCI to schedule the PUSCH, wherein the DCI indicates respective transmission precoding matrix indicators (TPMIs) to use for the respective PRGs.

Example C1 may include one or more computer-readable media having instructions, stored thereon, that when executed by one or more processors cause a user equipment (UE) to: identify a first codeword for transmission of a first set of layers of a physical uplink shared channel (PUSCH) and a second codeword for transmission of a second set of layers of the PUSCH; encode the first set of layers of the PUSCH for transmission based on the first codeword; and encode the second set of layers of the PUSCH for transmission based on the second codeword.

Example C2 may include the one or more computer-readable media of example C1, wherein a total number of layers in the first and second sets of layers is greater than 4.

Example C3 may include the one or more computer-readable media of example C1, wherein the instructions, when executed, are further to cause the UE to receive a downlink control information (DCI) to indicate one or more parameters of the first codeword and one or more parameters of the second codeword.

Example C4 may include the one or more computer-readable media of example C3, wherein the one or more parameters include a modulation and coding scheme (MCS), a new data indicator (NDI), a redundancy version, and a transmission precoding matrix indicator (TPMI).

Example C5 may include the one or more computer-readable media of example C4, wherein the DCI includes different fields for the parameters of the first codeword and the parameters of the second codeword.

Example C6 may include the one or more computer-readable media of example C5, wherein the DCI further includes different sounding reference signal (SRS) resource indicator (SRI) fields to indicate respective SRIs for the first and second codewords.

Example C7 may include the one or more computer-readable media of example C3, wherein the DCI further indicates one or more parameters that are used for both the first and second codewords.

Example C8 may include the one or more computer-readable media of any one of examples C1-C7, wherein the first set of layers are transmitted to a first transmission-reception point (TRP) and the second set of layers are transmitted to a second TRP.

Example C9 may include one or more computer-readable media having instructions, stored thereon, that when executed by one or more processors cause a next generation Node B (gNB) to: encode a downlink control information (DCI) for transmission to a UE, the DCI to indicate a first set of parameters of a first codeword for transmission of a first set of layers of a physical uplink shared channel (PUSCH) and a second set of parameters of a second codeword for transmission of a second set of layers of the PUSCH; and receive the first set of layers and/or the second set of layers of the PUSCH based on the respective first or second codeword.

Example C10 may include the one or more computer-readable media of example C9, wherein the first and second sets of layers each include 4 layers.

Example C11 may include the one or more computer-readable media of example C9, wherein the first and second sets of parameters each include a modulation and coding scheme (MCS), a new data indicator (NDI), a redundancy version, and a transmission precoding matrix indicator (TPMI).

Example C12 may include the one or more computer-readable media of example C11, wherein the DCI includes different fields for the first set of parameters and the second set of parameters.

Example C13 may include the one or more computer-readable media of example C9, wherein the DCI indicates one or more parameters that are used for both the first and second codewords.

Example C14 may include the one or more computer-readable media of any one of examples C9-C13, wherein the first set of layers are to be transmitted to a first transmission-reception point (TRP) and the second set of layers are to be transmitted to a second TRP.

Example C15 may include one or more computer-readable media having instructions, stored thereon, that when executed by one or more processors cause a user equipment (UE) to: receive a downlink control information (DCI) to indicate parameters for a codeword to be used for transmission of a physical uplink shared channel (PUSCH) with more than four layers; determine, based on the parameters, a precoder for the PUSCH with more than four layers; and encode the PUSCH for transmission based on the precoder.

Example C16 may include the one or more computer-readable media of example C15, wherein the PUSCH transmission has a rank x with eight antenna ports, wherein x is 1, 2, 3, or 4, and wherein the precoder is determined according to a Kronecker product of a rank-1 precoder with 2 ports and a rank-x precoder with 4 ports.

Example C17 may include the one or more computer-readable media of example C15, wherein the PUSCH transmission has a rank x with eight antenna ports, wherein x is 6 or 8, and wherein the precoder is determined according to a Kronecker product of a rank-2 precoder with 2 ports and a rank-(x/2) precoder with 4 ports.

Example C18 may include the one or more computer-readable media of example C15, wherein the PUSCH transmission has a rank x with eight antenna ports, wherein x is 5 or 7, and wherein the precoder is determined based on a rank-(x+1) precoder with one column removed.

Example C19 may include the one or more computer-readable media of any one of examples C15-C18, wherein the instructions, when executed, are further to cause the UE to encode a report for transmission, wherein the report indicates whether the UE supports two-port coherence or four-port coherence for the antenna ports.

Example Z01 may include an apparatus comprising means to perform one or more elements of a method described in or related to any of examples A1-A26, B1-B30, C1-C19, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A26, B1-B30, C1-C19, or any other method or process described herein.

Example Z03 may include an apparatus comprising logic, modules, or circuitry to perform one or more elements of a method described in or related to any of examples A1-A26, B1-B30, C1-C19, or any other method or process described herein.

Example Z04 may include a method, technique, or process as described in or related to any of examples A1-A26, B1-B30, C1-C19, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A26, B1-B30, C1-C19, or portions thereof.

Example Z06 may include a signal as described in or related to any of examples A1-A26, B1-B30, C1-C19, or portions or parts thereof.

Example Z07 may include a datagram, packet, frame, segment, protocol data unit (PDU), or message as described in or related to any of examples A1-A26, B1-B30, C1-C19, or portions or parts thereof, or otherwise described in the present disclosure.

Example Z08 may include a signal encoded with data as described in or related to any of examples A1-A26, B1-B30, C1-C19, or portions or parts thereof, or otherwise described in the present disclosure.

Example Z09 may include a signal encoded with a datagram, packet, frame, segment, protocol data unit (PDU), or message as described in or related to any of examples A1-A26, B1-B30, C1-C19, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A26, B1-B30, C1-C19, or portions thereof.

Example Z11 may include a computer program comprising instructions, wherein execution of the program by a processing element is to cause the processing element to carry out the method, techniques, or process as described in or related to any of examples A1-A26, B1-B30, C1-C19, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time Rx Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-19. (canceled)

20. One or more non-transitory computer-readable media having instructions, stored thereon, that when executed by one or more processors cause a user equipment (UE) to:
identify a first codeword for transmission of a first set of layers of a physical uplink shared channel (PUSCH) and a second codeword for transmission of a second set of layers of the PUSCH;
encode the first set of layers of the PUSCH for transmission based on the first codeword; and
encode the second set of layers of the PUSCH for transmission based on the second codeword.

21. The one or more computer-readable media of claim 20, wherein a total number of layers in the first and second sets of layers is greater than 4.

22. The one or more computer-readable media of claim 20, wherein the instructions, when executed, are further to cause the UE to receive a downlink control information (DCI) to indicate one or more parameters of the first codeword and one or more parameters of the second codeword.

23. The one or more computer-readable media of claim 22, wherein the one or more parameters include a modulation and coding scheme (MCS), a new data indicator (NDI), a redundancy version, and a transmission precoding matrix indicator (TPMI).

24. The one or more computer-readable media of claim 23, wherein the DCI includes different fields for the parameters of the first codeword and the parameters of the second codeword.

25. The one or more computer-readable media of claim 24, wherein the DCI further includes different sounding reference signal (SRS) resource indicator (SRI) fields to indicate respective SRIs for the first and second codewords.

26. The one or more computer-readable media of claim 22, wherein the DCI further indicates one or more parameters that are used for both the first and second codewords.

27. The one or more computer-readable media of claim 20, wherein the first set of layers are transmitted to a first transmission-reception point (TRP) and the second set of layers are transmitted to a second TRP.

28. One or more non-transitory computer-readable media having instructions, stored thereon, that when executed by one or more processors cause a next generation Node B (gNB) to:
encode a downlink control information (DCI) for transmission to a UE, the DCI to indicate a first set of parameters of a first codeword for transmission of a first set of layers of a physical uplink shared channel (PUSCH) and a second set of parameters of a second codeword for transmission of a second set of layers of the PUSCH; and
receive the first set of layers and/or the second set of layers of the PUSCH based on the respective first or second codeword.

29. The one or more computer-readable media of claim 28, wherein the first and second sets of layers each include 4 layers.

30. The one or more computer-readable media of claim 28, wherein the first and second sets of parameters each include a modulation and coding scheme (MCS), a new data indicator (NDI), a redundancy version, and a transmission precoding matrix indicator (TPMI).

31. The one or more computer-readable media of claim 30, wherein the DCI includes different fields for the first set of parameters and the second set of parameters.

32. The one or more computer-readable media of claim 28, wherein the DCI indicates one or more parameters that are used for both the first and second codewords.

33. The one or more computer-readable media of claim 28, wherein the first set of layers are to be transmitted to a first transmission-reception point (TRP) and the second set of layers are to be transmitted to a second TRP.

34. An apparatus to be implemented in a user equipment (UE), the apparatus comprising:
a memory to store parameters for a codeword to be used for transmission of a physical uplink shared channel (PUSCH) with more than four layers; and
processor circuitry to:
determine, based on the parameters, a precoder for the PUSCH with more than four layers; and
encode the PUSCH for transmission based on the precoder.

35. The apparatus of claim 34, wherein the PUSCH transmission has a rank x with eight antenna ports, wherein x is 1, 2, 3, or 4, and wherein the precoder is determined according to a Kronecker product of a rank-1 precoder with 2 ports and a rank-x precoder with 4 ports.

36. The apparatus of claim 34, wherein the PUSCH transmission has a rank x with eight antenna ports, wherein x is 6 or 8, and wherein the precoder is determined according to a Kronecker product of a rank-2 precoder with 2 ports and a rank-(x/2) precoder with 4 ports.

37. The apparatus of claim 34, wherein the PUSCH transmission has a rank x with eight antenna ports, wherein x is 5 or 7, and wherein the precoder is determined based on a rank-(x+1) precoder with one column removed.

38. The apparatus of claim 34, wherein the processor circuitry is further to encode a report for transmission, wherein the report indicates whether the UE supports two-port coherence or four-port coherence for the antenna ports.

39. The apparatus of claim 34, wherein the parameters are received via a downlink control information (DCI).
